(19) United States
(12) Patent Application Publication
(10) Pub. No.: US 2025/0306510 A1
(43) Pub. Date: Oct. 2, 2025

(54) FIXING UNIT

(71) Applicant: CANON KABUSHIKI KAISHA, Tokyo (JP)

(72) Inventors: SHUTARO SAITO, Tokyo (JP); YUTARO OKADA, Chiba (JP); TAKUMA TADOMI, Chiba (JP); KOHEI AOKI, Chiba (JP); YUSHI SADAMITSU, Tokyo (JP); TOSHINORI NAKAYAMA, Chiba (JP); YASUHARU CHIYODA, Chiba (JP); YUSUKE YAMAGUCHI, Chiba (JP); HIDEFUMI YOSHIDA, Chiba (JP); SHINICHI ISOZAKI, Saitama (JP); YOSUKE OBAYASHI, Chiba (JP)

(21) Appl. No.: 19/077,483

(22) Filed: Mar. 12, 2025

(30) Foreign Application Priority Data
Mar. 27, 2024 (JP) 2024-051922

(51) Int. Cl. G03G 15/20; G03G 15/00; G03G 21/20

(52) U.S. Cl. CPC G03G 15/2053; G03G 15/205; G03G 15/2064; G03G 15/5004; G03G 15/80; G03G 21/206

(57) ABSTRACT

A heater is disposed inside the belt in such a manner as not to be in contact with the belt and heats the belt by emitting an electromagnetic wave. A reflecting member reflects the electromagnetic wave emitted by the heater toward a region of the belt. The heater is disposed inside the reflecting member. A temperature detection unit is disposed outside the reflecting member and detects a temperature of the region. A fan generates an airflow. A flow path forming portion is provided inside the belt and forms a flow path through which the airflow generated from the fan flows. The temperature detection unit is disposed inside the flow path forming portion.

### BACKGROUND OF THE INVENTION

### Field of the Invention

The present invention relates to a fixing unit that heats a sheet on which an image is formed by ejecting ink to fix the image onto the sheet.

### Description of the Related Art

Japanese Patent Application Laid-Open Publication No. 2018-136392 describes a configuration in which a temperature of a heater is measured using a sensor disposed on the heater that heats a belt, and energization control with respect to the heater is changed when an abnormal temperature rise is detected.

### SUMMARY OF THE INVENTION

According to a first aspect of the present invention, a fixing unit includes an endless belt configured to heat a sheet on which an ink image is formed to fix the image onto the sheet, a heater disposed inside the belt in such a manner as not to be in contact with the belt and configured to heat the belt by emitting an electromagnetic wave, a reflecting member configured to reflect the electromagnetic wave emitted by the heater toward a region of the belt, with the heater being disposed inside the reflecting member, a temperature detection unit disposed outside the reflecting member and configured to detect a temperature of the region, a fan configured to generate an airflow, and, a flow path forming portion provided inside the belt and forming a flow path through which the airflow generated from the fan flows. The temperature detection unit is disposed inside the flow path forming portion.

According to a second aspect of the present invention, a fixing unit includes an endless belt configured to heat a sheet on which an ink image is formed to fix the image onto the sheet, a first heater and a second heater disposed inside the belt in such a manner as not to be in contact with the belt and configured to heat the belt by emitting electromagnetic waves, a first reflecting member configured to reflect the electromagnetic wave emitted by the first heater toward a first region of the belt, with the first heater being disposed inside the first reflecting member, a second reflecting member configured to reflect the electromagnetic wave emitted by the second heater toward a second region of the belt, with the second heater being disposed inside the second reflecting member, a temperature detection unit disposed outside the first reflecting member and the second reflecting member, and configured to detect a temperature one of the first region and the second region, and, a fan configured to generate an airflow. The airflow generated from the fan flows in a width direction of the belt intersecting a rotation direction of the belt along a part of the first reflecting member and a part of the second reflecting member. The temperature detection unit is disposed in a flow path through which the airflow generated from the fan flows.

Further features of the present invention will become apparent from the following description of exemplary embodiments with reference to the attached drawings.

### BRIEF DESCRIPTION OF THE DRAWINGS

FIG. 1 is a cross-sectional view illustrating a schematic configuration of an inkjet recording apparatus according to a first embodiment.

FIG. 2 is a cross-sectional view illustrating a schematic configuration of a fixing module according to the first embodiment.

FIG. 3A is an enlarged cross-sectional view illustrating a schematic configuration of a part of a fixing belt unit according to the first embodiment.

FIG. 3B is a cross-sectional view illustrating a heater and a reflector of the fixing belt unit according to the first embodiment.

FIG. 4 is a perspective view illustrating a configuration around fans according to the first embodiment.

FIG. 5 is a cross-sectional view of the fixing belt unit cut along a width direction in a fan and a flow path according to the first embodiment.

FIG. 6A is a perspective view illustrating a first state in which an upper door unit is located at a closed position of the fixing module according to the first embodiment.

FIG. 6B is a perspective view illustrating a second state in which the upper door unit is located at an open position and an upper belt unit is located at an upper storage position of the fixing module according to the first embodiment.

FIG. 6C is a perspective view illustrating a third state in which the upper door unit is located at the open position and the upper belt unit is located at a maintenance position of the fixing module according to the first embodiment.

FIG. 7 is a block diagram related to fixing control of the upper belt unit according to the first embodiment.

FIG. 8 is a flowchart related to the fixing control of the upper belt unit according to the first embodiment.

FIG. 9A is a plan view and a side view of a temperature sensor according to the first embodiment.

FIG. 9B is a schematic view illustrating a viewing angle of the temperature sensor according to the first embodiment.

FIG. 9C is a graph illustrating a relationship between a viewing angle and a measurement accuracy.

FIG. 10A is a schematic view illustrating a relationship between the heater and the belt in the width direction according to the first embodiment, and a diagram illustrating a radiant intensity distribution in the width direction of the heater.

FIG. 10B is a graph illustrating a relationship between a heating time and a temperature of the belt.

FIG. 11 is a diagram illustrating an ambient temperature distribution in a flow path in which the temperature sensor is disposed according to the first embodiment.

FIG. 12 is an enlarged cross-sectional view illustrating a schematic configuration of a part of a fixing belt unit according to a second embodiment.

FIG. 13 is a block diagram related to fixing control of an upper belt unit according to the second embodiment.

FIG. 14 is a cross-sectional view of the fixing belt unit cut along a width direction in a fan and a flow path according to the second embodiment.

FIG. 15 is a schematic cross-sectional view mainly illustrating a heating configuration in which a part of an upper belt unit is omitted according to a third embodiment.

FIG. 16 is a schematic view illustrating temperature sensors, reflectors, and a belt as viewed from above the reflectors according to a fourth embodiment.

FIG. 17A is a schematic view of the temperature sensors, the reflectors, and the belt as viewed from the side according to the fourth embodiment.

FIG. 17B is a graph illustrating a relationship between a heating time and a temperature of the belt.

FIG. 18 is a schematic cross-sectional view mainly illustrating a heating configuration in which a part of an upper belt unit is omitted according to a fifth embodiment.

### DESCRIPTION OF THE EMBODIMENTS

### First Embodiment

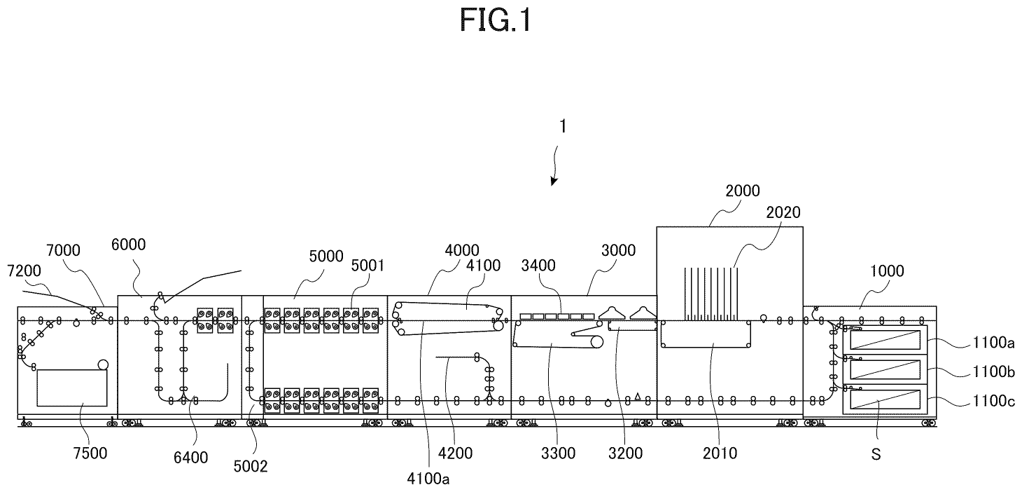

A first embodiment will be described with reference to FIGS. 1 to 11. First, a schematic configuration of an inkjet recording apparatus of the present embodiment will be described with reference to FIG. 1.

### An Inkjet Recording Apparatus

The inkjet recording apparatus 1 serving as an image forming system of the present embodiment uses an inkjet recording system that ejects ink to form an image on a sheet, and is a so-called sheet-type inkjet recording apparatus that forms an ink image on a sheet using two liquids of a reaction liquid and ink. The sheet may be, for example, a recording material capable of receiving ink, such as paper such as plain paper or thick paper, a plastic film such as a sheet for an overhead projector, a sheet having a special shape such as an envelope or index paper, and cloth.

As illustrated in FIG. 1, the inkjet recording apparatus 1 of the present embodiment includes a feeding module 1000, a print module 2000, a drying module 3000, a fixing module 4000, a cooling module 5000, a reverse module 6000, and a stacking module 7000. When the sheet S supplied from the feeding module 1000 is conveyed along a conveyance path in each module, various processing is performed, and the sheet S is finally discharged to the stacking module 7000.

Note that the feeding module 1000, the print module 2000, the drying module 3000, the fixing module 4000, the cooling module 5000, the reverse module 6000, and the stacking module 7000 may have separate casings, and these casings may be connected to configure the inkjet recording apparatus 1. Alternatively, the feeding module 1000, the print module 2000, the drying module 3000, the fixing module 4000, the cooling module 5000, the reverse module 6000, and the stacking module 7000 may be disposed in one casing.

The feeding module 1000 includes storage compartments 1100a, 1100b, and 1100c that store the sheet S, and the storage compartments 1100a to 1100c are provided to be drawable toward the front side of the apparatus in order to store the sheet S. The sheets S are fed one by one by a separation belt and a conveying roller in each of the storage compartments 1100a to 1100c, and conveyed to the print module 2000. The number of storage compartments 1100a to 1100c is not limited to 3, and may be 1, 2, or 4 or more.

The print module 2000 serving as an image forming unit includes a pre-image formation registration correction unit (not illustrated), a print belt unit 2010, and a recording unit 2020. The sheet S conveyed from the feeding module 1000 is corrected an inclination and a position of the sheet S by the pre-image formation registration correction unit and conveyed to the print belt unit 2010. The recording unit 2020 is disposed at a position facing the print belt unit 2010 across the conveyance path. The recording unit 2020 is an inkjet recording unit that forms an image by ejecting ink onto the sheet S by a recording head from above with respect to the conveyed sheet S. A plurality of recording heads that eject ink is arranged along a conveyance direction. In the present embodiment, in addition to four colors of yellow (Y), magenta (M), cyan (C), and black (Bk), a total of five line type recording heads corresponding to the reaction liquid are provided. The sheet S is sucked and conveyed by the print belt unit 2010 to secure a clearance with the recording head.

Note that the number of colors of ink and the number of recording heads are not limited to the above-described five. As the inkjet method, a method using a heat generating element, a method using a piezoelectric element, a method using an electrostatic element, a method using a micro electro mechanical systems (MEMS) element, and the like can be adopted. The ink of each color is supplied from each ink tank (not illustrated) to each recording head via each ink tube. The ink contains “0.1 mass % to 20.0 mass %” of a resin component, water, a water-soluble organic solvent, a coloring material, wax, an additive, and the like on the basis of the total mass of the ink.

When the sheet S on which an image is formed by the recording unit 2020 is conveyed by the print belt unit 2010, deviation and color density of the image formed on the sheet S are detected by an in-line scanner (not illustrated) arranged downstream of the recording unit 2020 in the conveyance direction of the sheet S. Based on the deviation and the color density of the image detected by the in-line scanner, deviation of an image, density of an image, and the like to be formed on the sheet S are corrected.

The drying module 3000 serving as a drying apparatus includes a decoupling unit 3200, a drying belt unit 3300, and a warm air blowing unit 3400. The drying module 3000 reduces the liquid content of the ink and the reaction liquid applied to the sheet S in order to enhance the fixability of the ink to the sheet S by the subsequent fixing module 4000. The sheet S on which the image is formed is conveyed to the decoupling unit 3200 disposed in the drying module 3000. In the decoupling unit 3200, a frictional force is generated between the sheet S and the belt by the wind pressure of the wind blown from above, and the sheet S is conveyed by the belt. In this way, by conveying the sheet S placed on the belt by frictional force, deviation of the sheet S when the sheet S is conveyed over the print belt unit 2010 and the decoupling unit 3200 is prevented. The sheet S conveyed from the decoupling unit 3200 is sucked and conveyed by the drying belt unit 3300, and the hot air is blown from the warm air blowing unit 3400 disposed above the belt to dry the ink and the reaction liquid applied to the sheet S.

In this way, by heating the ink and the reaction liquid applied to the sheet S by the drying module 3000 and accelerating evaporation of moisture, it is possible to suppress an occurrence of so-called cockling in which the ink is scattered on the sheet S and a border-like line is formed around the sheet S. As the drying module 3000, any device may be used as long as it is capable of drying the ink in a heating manner. For example, a hot air dryer or a heater is preferable. As an example of the heater, an electric wire heater or an infrared heater is preferable from the viewpoint of heating safety and heating energy efficiency. The drying method may be a combination of a method of applying hot air and a method of irradiating the surface of the sheet S with an electromagnetic wave (ultraviolet ray, infrared ray, or the like) or a conductive heat transfer method using contact with a heating element.

The fixing module 4000 serving as a fixing system includes a fixing belt unit 4100 serving as a fixing unit. The fixing belt unit 4100 causes the sheet S conveyed from the drying module 3000 to pass between a heated upper belt unit and lower belt unit to fix the ink to the sheet S. The fixing belt unit 4100 will be described in detail below.

The cooling module 5000 includes a plurality of cooling units 5001, and cools the high-temperature sheet S conveyed from the fixing module 4000 by the cooling units 5001. For example, each of the cooling units 5001 takes outside air into a cooling box by a fan to increase the pressure in the cooling box, and blows air blown from the cooling box through the nozzle by the pressure against the sheet S to cool the sheet S. The cooling units 5001 are disposed on each of both sides of the conveyance path of the sheet S and cools both surfaces of the sheet S.

A conveyance path switching unit 5002 is provided in the cooling module 5000. The conveyance path switching unit 5002 switches the conveyance path of the sheet S according to the case of conveying the sheet S to the reverse module 6000 and the case of conveying the sheet S to a duplex conveyance path for duplex printing for forming an image on both surfaces of the sheet S.

The reverse module 6000 includes a reverse portion 6400. The reverse portion 6400 reverses the front and back sides of the conveyed sheet S and changes the front and back sides of the sheet S when the sheet S is discharged to the stacking module 7000. The stacking module 7000 includes a top tray 7200 and a stacking portion 7500, and stacks the sheet S conveyed from the reverse module 6000.

During duplex printing, the sheet S is conveyed to a conveyance path below the cooling module 5000 by the conveyance path switching unit 5002. Thereafter, the sheet S is returned to the print module 2000 through the duplex conveyance path of the fixing module 4000, the drying module 3000, the print module 2000, and the feeding module 1000. A reverse portion 4200 that reverses the front and back of the sheet S is provided in a duplex conveying portion of the fixing module 4000. The sheet S returned to the print module 2000 has an image formed by ink on the other surface on which no image is formed, and is discharged to the stacking module 7000 through the drying module 3000, the fixing module 4000, the cooling module 5000, and the reverse module 6000.

### Fixing Module

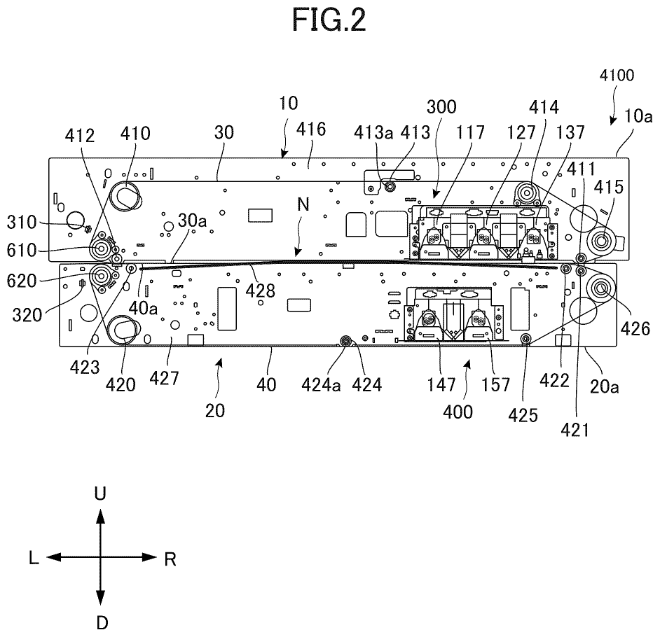

Next, the fixing module 4000 will be described in detail with reference to FIG. 2. FIG. 2 is a schematic view illustrating the fixing module 4000. The fixing belt unit 4100 serving as a fixing unit is provided at the upper portion of the fixing module 4000. The fixing belt unit 4100 has a substantially linear sheet conveyance path 4100a for receiving the sheet S discharged from the drying module 3000, fixing the sheet S, and then delivering the sheet S to the cooling module 5000 (see FIG. 1). In each drawing, a front side of the inkjet recording apparatus 1 is referred to as a front direction F, a back side thereof is referred to as a rear direction B, a right side thereof as viewed from the front is referred to as a rightward direction R, a left side thereof as viewed from the right is referred to as a left direction L, an upper side thereof is referred to as an up direction U, and a lower side thereof is referred to as a down direction D. An operation unit (not illustrated) operated by an operator is provided on the front side of the inkjet recording apparatus.

The fixing belt unit 4100 includes an upper belt unit 10 and a lower belt unit 20. The upper belt unit 10 is disposed above the lower belt unit 20 in the vertical direction. The upper belt unit 10 includes an upper belt 30, which is an example of a belt or a first belt, and a tension roller 410 (stretching member or first stretching member) that applies tension to the upper belt 30. That is, the upper belt unit 10 is an example of a belt unit (first belt unit), and detachably includes an upper belt 30 that conveys the sheet S. The lower belt unit 20 is an example of a second belt unit, and includes a lower belt 40 that is an example of a nip portion forming member or a second belt, a tension roller 420 (second stretching member) that applies tension to the lower belt 40, and a pad 428 having an arc-shaped curved surface. The pad 428 is disposed to form a nip with the upper belt 30 via the lower belt 40.

The sheet S is conveyed while being nipped by the nip between the upper belt unit 10 and the lower belt unit 20. That is, as will be described below, the lower belt 40 is disposed to face the upper belt unit 10 when an upper door unit 43 is located at a closed position and the upper belt unit 10 is located at an upper storage position. At this time, the lower belt 40 nips and conveys the sheet S together with the upper belt 30. The pressure of the nip is determined by the tension and thickness of the upper belt 30 and the curvature of the pad 428. When the pressure of the nip is too high, there is a possibility that a phenomenon occurs in which the ink on the sheet S adheres to the upper belt unit 10 and the ink is peeled off from the sheet S. Therefore, the pressure is preferably 1 Pa to 2000 Pa, and more preferably 1 Pa to 200 Pa.

When the curvature of the pad 428 is large, the conveyance path difference between the front and back surfaces of the sheet S is large, and there is a possibility that the sheet S and the belt rub against each other. When the curvature of the pad 428 is large, there is a possibility that a phenomenon occurs in which the sheet S itself memorizes the curved shape and curls. Therefore, the curvature radius of the pad 428 is desirably 50 mm or more. In addition, the curvature of the pad 428 desirably has a curvature radius of 100,000 mm or less from the viewpoint of manufacturing accuracy. Due to these restrictions, in the present embodiment, the tension of the upper belt 30 is set to 200 N, the thickness of the upper belt 30 is set to 0.3 mm, the curvature of the pad 428 is set to 30,000 mm, and the pressure of the nip is set to about 16 Pa.

By adopting such a configuration, even a wide nip can be uniformly pressurized. As a result, even in a state where the temperature of the upper belt unit 10 is a temperature corresponding to the melting point of wax or the boiling point of water, heat can be sufficiently transferred to the sheet S by increasing the contact time between the sheet S and the upper belt unit 10. However, if the nip is continuously formed after the heat is sufficiently transferred, a phenomenon occurs in which the ink adheres to the upper belt 30 and the ink is peeled off from the sheet S, or a phenomenon occurs in which the upper belt 30 and the sheet S rub against each other and the image is disturbed. Therefore, an excessively long contact time is not preferable. Therefore, the time taken for the leading end of the sheet S to emerge from an outlet of the nip after entering an inlet of the nip is desirably 0.5 s to 4 s. In the present embodiment, the sheet S is conveyed at 700 mm/s using the pad 428 having a length of 900 mm in the sheet conveyance direction, with the time required for the leading end of the sheet S to emerge from the outlet of the nip after entering the inlet of the nip being about 1.3 s. Note that since moisture is necessary when the ink penetrates into the sheet S, the upper belt 30 and the lower belt 40 are preferably impermeable to moisture so that moisture evaporated from the surface of the sheet S when the sheet becomes too hot does not escape through the upper belt 30 or lower belt 40 that the surface of the sheet S contacts. In the present embodiment, for the upper belt 30 and the lower belt 40, a belt material having a thickness of about 0.4 mm obtained by applying a polytetrafluoroethylene (PTFE) coating to a surface of a glass fiber base material is used in consideration of heat resistance, slidability, sealability, and durability.

### Fixing Belt Unit

As described above, the fixing belt unit 4100 serving as a fixing unit includes the upper belt unit 10 and the lower belt unit 20, and the upper belt 30 of the upper belt unit 10 and the lower belt 40 of the lower belt unit 20 are brought into pressure contact with each other to form a nip portion N. The sheet S1 is conveyed while being nipped by the nip portion N, and an image formed by the ink is fixed onto the sheet S1 by applying pressure and heat at that time.

The upper belt unit 10 includes an endless upper belt 30 serving as a belt or a first belt, a plurality of stretching rollers serving as a plurality of first stretching members that stretch the upper belt 30, and a first heating unit 300. The plurality of stretching rollers are an inlet roller 411, an outlet roller 412, a driving roller 610, a tension roller 410, a guide roller 413, a guide roller 414, and a steering roller 415. These rollers are arranged in order from the upstream side of the nip portion N in the rotation direction of the upper belt 30, and a rotation locus of the upper belt 30 is thereby formed.

In addition, the nip portion N exists between the inlet roller 411 and the outlet roller 412. That is, the inlet roller 411 and the outlet roller 412 are disposed to sandwich the nip portion N therebetween in the rotation direction of the upper belt 30. In addition, the upper belt 30 is stretched by the inlet roller 411 and the outlet roller 412 to form a first stretched surface 30a. Each roller is supported by an upper frame 416 serving as a first frame, which is a casing of the upper belt unit 10.

The lower belt unit 20 includes an endless lower belt 40 serving as a belt or a second belt, a plurality of stretching rollers serving as a plurality of second stretching members that stretch the lower belt 40, and a second heating unit 400. The plurality of stretching rollers are a nip upstream guide roller 421, a nip upstream roller 422, a nip downstream roller 423, a driving roller 620, a tension roller 420, a guide roller 424, a guide roller 425, and a steering roller 426. These rollers are arranged in order from the upstream side of the nip portion N in the rotation direction of the lower belt 40.

In addition, the nip portion N exists between the nip upstream roller 422 and the nip downstream roller 423, and the pad 428 is disposed in the nip portion N. That is, the nip upstream roller 422 and the nip downstream roller 423 are disposed to sandwich the nip portion N therebetween in the rotation direction of the lower belt 40. The pad 428 serving as a supporting member abuts on an inner peripheral surface of the lower belt 40 in the region of the nip portion N to support the lower belt 40. In other words, the nip upstream roller 422 and the nip downstream roller 423 are disposed on both sides of the pad 428 in the rotation direction of the lower belt 40. In addition, the lower belt 40 is stretched by the nip upstream roller 422 and the nip downstream roller 423 to form a second stretched surface 40a. The nip portion N is formed between the first stretched surface 30a of the upper belt 30 and the second stretched surface 40a. A rotation locus of the lower belt 40 is formed by the rollers and the pad 428. The rollers and the pad 428 are supported by a lower frame 427 serving as a second frame, which is a casing of the lower belt unit 20.

The upper belt 30 and the lower belt 40 are driven to rotate by the frictional force between the surface of the roller 610 and the inner surface of the belt 30 and the surface of the roller 620 and the inner surface of the belt 40 when the driving rollers 610 and 620 of the respective belt units are rotated by respective motors (not illustrated). Rotation detection sensors 413a and 424a are disposed on rotation shafts of the guide rollers (driven rollers) 413 and 424 that are driven to rotate by rotation of the upper belt 30 and the lower belt 40. The rotation detection sensors 413a and 424a are elements constituted by magnets whose magnetic force is changed in the rotation direction of the guide rollers 413 and 424, and detect the rotation of the upper belt 30 and the lower belt 40 by detecting changes in N and S poles caused by the rotation by a Hall sensor (not illustrated). In the present embodiment, the rotation detection sensor is an element constituted by a magnet, but a transmissive sensor that detects changes in light shielding and light transmission using a physical flag having an edge in the rotation direction of the driven roller may be used.

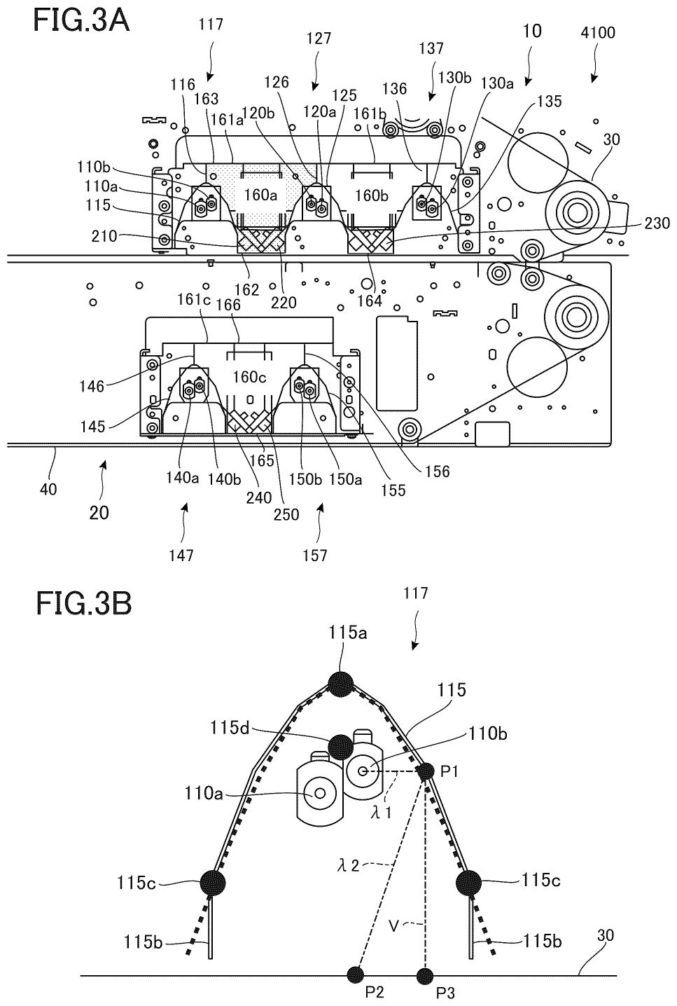

Next, the first heating unit 300 and the second heating unit 400 of the respective belt units will be described. The first heating unit 300 is disposed inside the upper belt 30, and includes heating portions 117, 127, and 137. The heating portions include heaters 110a, 110b, 120a, 120b, 130a, and 130b, and reflectors (reflecting plates) 115, 125, and 135 serving as reflecting members, respectively (see FIG. 3A). The first heating unit 300 is attachable to and detachable from a first belt unit body 10a including the upper belt 30.

The heaters 110a, 110b, 120a, 120b, 130a, and 130b included in heating portions 117, 127, and 137, 30, 30 are disposed along a width direction of the upper belt 30 that intersects the rotation direction of the upper belt 30 not to be in contact with the upper belt 30 to heat the upper belt 30 by radiating heat. The reflectors 115, 125, and 135 are disposed along the width direction, and reflect electromagnetic waves (radiant heat) emitted from the heaters 110a, 110b, 120a, 120b, 130a, and 130b toward certain regions of the upper belt 30.

In the present embodiment, the first heating unit 300 of the upper belt unit 10 is disposed inside the upper belt 30 and above the nip portion N to heat the upper belt 30 from the inside. The first heating unit 300 includes a plurality of heating portions 117, 127, and 137. In the present embodiment, the three heating portions 117, 127, and 137 are arranged side by side in the rotation direction of the upper belt 30.

The reflectors 115, 125, and 135 are disposed to cover the peripheries of the heaters 110a, 110b, 120a, 120b, 130a, and 130b except for the side facing the upper belt 30. That is, the reflectors 115, 125, and 135 are formed such that the heaters 110a, 110b, 120a, 120b, 130a, and 130b are open toward the nip portion N and both ends of the heaters 110a, 110b, 120a, 120b, 130a, and 130b in the width direction are covered. As a result, the reflectors 115, 125, and 135 efficiently radiate the radiant heat of the heaters 110a, 110b, 120a, 120b, 130a, and 130b toward the nip portion N.

That is, in the upper belt unit 10, the certain regions are regions of the inner peripheral surface of the upper belt 30 within the range of the nip portion N, and the nip portion Nis directly heated by the plurality of heating portions 117, 127, and 137. As a result, heat can be efficiently transferred to the sheet S passing through the nip portion N. In the present embodiment, the regions within the range of the nip portion N heated by the plurality of heating portions 117, 127, and 137 are regions of the inner peripheral surface (lower surface portion) of the upper belt 30, and are regions located upstream of the central position of the nip portion N in the direction of the sheet S passing through the nip portion Nis conveyed. In addition, the heating portions 117, 127, and 137 perform temperature adjustment control such that the temperature of the upper belt 30 is maintained at a predetermined temperature, by controlling the input power based on a value detected by a temperature sensor 310 that detects the surface temperature of the upper belt 30.

The second heating unit 400 is disposed inside the lower belt 40, and includes heating portions 147 and 157. The heating portions include heaters 140a, 140b, 150a, and 150b, and reflectors (reflecting plates) 145 and 155 serving as reflecting members, respectively (see FIG. 3A). The second heating unit 400 is attachable to and detachable from a second belt unit body 20a including the lower belt 40.

The heaters 140a, 140b, 150a, and 150b included in the heating portions 147 and 157 are disposed along a width direction of the lower belt 40 that intersects the rotation direction of the lower belt 40 not to be in contact with the lower belt 40 to heat the lower belt 40 by radiating heat. The reflectors 145 and 155 are disposed along the width direction, and reflect electromagnetic waves (radiant heat) emitted from the heaters 140a, 140b, 150a, and 150b toward certain regions of the lower belt 40.

In the present embodiment, the second heating unit 400 of the lower belt unit 20 is disposed inside the lower belt 40 and below the nip portion N to heat the lower belt 40 from the inside. The second heating unit 400 includes a plurality of heating portions 147 and 157. In the present embodiment, the two heating portions 147 and 157 are arranged side by side in the rotation direction of the lower belt 40.

The reflectors 145 and 155 are disposed to cover the peripheries of the heaters 140a, 140b, 150a, and 150b except for the side facing the lower belt 40. That is, the reflectors 145 and 155 are formed such that the heaters 140a, 140b, 150a, and 150b are open downward and both ends of the heaters 140a, 140b, 150a, and 150b in the width direction are covered. Thus, the reflectors 145 and 155 efficiently radiate the radiant heat of the heaters 140a, 140b, 150a, and 150b toward the lower portion of the lower belt 40.

That is, in the lower belt unit 20, the certain regions are regions of the inner peripheral surface of the lower belt 40 outside the nip portion N, and is a lower portion of the lower belt 40 in the present embodiment. Specifically, the regions heated by the plurality of heating portions 147 and 157 are regions of the inner peripheral surface (lower surface portion) of the lower belt 40 between the guide roller 424 and the guide roller 425 in the rotation direction of the lower belt 40. That is, the certain regions of the lower belt unit 20 are regions of a surface of the lower belt 40 stretched in the substantially horizontal direction by the guide roller 424 and the guide roller 425. As described above, the lower belt unit 20 is provided with the pad 428 at a position corresponding to the nip portion N, and cannot directly heat the nip portion N unlike the upper belt unit 10. Therefore, by arranging the plurality of heating portions 147 and 157 to face the above-described region of the lower belt 40, the lower belt 40 is efficiently heated in a direct manner.

The regions of the lower belt 40 heated by the plurality of heating portions 147 and 157 are on the downstream side in the rotation direction of the lower belt 40 with respect to the central position between the guide roller 425 and the tension roller 420 that stretch the lower portion of the lower belt 40 in the rotation direction of the lower belt 40. Therefore, the lower belt 40 can be heated at a position relatively close to the nip portion N by the plurality of heating portions 147 and 157, and heat can be efficiently transferred to the sheet S passing through the nip portion N. In addition, the heating portions 147 and 157 perform temperature adjustment control such that the temperature of the lower belt 40 is maintained at a predetermined temperature, by controlling the input power based on a value detected by a temperature sensor 320 that detects the surface temperature of the lower belt 40.

When the rotation detection sensors 413a and 424a detect the rotation of the belt has been stopped, the heating by the heating portions 117, 127, 137, 147, and 157 is stopped. As a result, it is possible to suppress an occurrence of local heating caused by heating in a state where the upper belt 30 and the lower belt 40 are stopped.

### Heating Portion

Next, the heating portions 117, 127, 137, 147, and 157 will be described in detail with reference to FIGS. 3A and 3B. FIG. 3A is an enlarged cross-sectional view illustrating the peripheries of the heating portions 117, 127, 137, 147, and 157 of the fixing belt unit 4100, and FIG. 3B is a cross-sectional view illustrating the heaters 110a and 110b and the reflector 115. Since the heating portions 117, 127, 137, 147, and 157 provided in the upper belt unit 10 and the lower belt unit 20 basically have a common configuration, the common configuration will be described by taking the heating portion 117 as a representative.

The heating portion 117 includes two heaters 110a and 110b having different maximum powers. The ends of the heaters 110a and 110b in the width direction are supported by a support portion (not illustrated). The heaters 110a and 110b in the present embodiment are halogen heaters, and the heater 110a is a heater to which a power higher than that of the heater 110b can be supplied. That is, the heater 110a corresponds to a first heater, and the heater 110b corresponds to a second heater having a power lower than that of the heater 110a.

The heaters 110a and 110b are covered with the reflector 115, and heat the upper belt 30 immediately below the heaters 110a and 110b. The reflector 115 is formed, for example, using a mirror-finished aluminum member or the like, and reflects light generated from the heaters 110a and 110b to concentrate the light on a certain region of the upper belt 30.

As illustrated in FIG. 3B, the reflector 115 has a shape having a part of a parabola. The reflector 115 is a parabola having a reflector apex 115a as an apex. The parabolic shape formed in a direction from the reflector apex 115a toward the upper belt 30 extends to reflector parabola end points 115c, and then extends toward the upper belt 30 in a substantially vertical direction to form reflector straight portions 115b. Note that the shape of the reflector 115 may be approximated by a polygonal shape made up of a plurality of line segments due to restrictions in manufacturing parts or the like. The reflector straight portions 115b are preferably arranged as short as possible (which may be 0), but are provided to secure a space for arranging a temperature sensor 210 to be described below.

With respect to a focal point (reflector focal point) 115d of the parabola guided by the reflector apex 115a and the reflector parabola end points 115c, the heaters 110a and 110b are disposed closer to the upper belt 30 than the reflector focal point 115d, and are disposed with a difference in height in the up-down direction. Further, the heater 110a to which a high power can be supplied is disposed to be shifted downward from the heater 110b.

That is, the cross-sectional shape of the reflector 115 includes the reflector apex 115a, the reflector parabola end point 115c, and the reflector straight portion 115b extending from the reflector parabola end point 115c toward the upper belt 30. With respect to the focal point 115d of the approximate parabola passing through the reflector apex 115a and the reflector parabola end point 115c, the two heaters 110a and 110b are disposed at positions closer to the upper belt 30 than the focal point 115d, and the two heaters 110a and 110b are located at different distances from the upper belt 30.

The positions of the heaters 110a and 110b can be defined as follows. Since the heaters 110a and 110b satisfy the following requirements, the heater 110b will be described as a representative below. First, a line drawn from the heater 110b toward the reflector 115 in a direction orthogonal to the perpendicular line drawn from the heater 110b to the upper belt 30 and orthogonal to the width direction of the upper belt 30 intersecting the rotation direction of the upper belt 30 is defined as an incident light segment 21. A point at which the incident light segment λ1 intersects the inner surface of the reflector 115 is defined as a first intersection P1. A line drawn from the first intersection P1 such that an incident angle and a reflection angle are the same in relation to the incident light segment λ1 is defined as a reflected light segment 22. A point at which the reflected light segment 22 intersects the upper belt 30 is defined as a second intersection P2. A point where a perpendicular line V drawn from the first intersection P1 to the upper belt 30 intersects the upper belt 30 is defined as a third intersection P3. In this case, the heater 110b is disposed such that the second intersection P2 is closer to the heater 110b than to the third intersection P3 in the rotation direction of the upper belt 30.

By arranging the heaters 110a and 110b at positions closer to the upper belt 30 than the reflector focal point 115d, it is possible to reduce the rate at which light generated from the heaters 110a and 110b is reflected by the reflector 115, and it is possible to increase the efficiency in heating the upper belt 30. On the other hand, if the heaters 110a and 110b are too close to the upper belt 30, the heating efficiency can be enhanced, but the intensity distribution of the light irradiated onto the upper belt 30 is more biased. In addition, by arranging the two heaters 110a and 110b with a difference in height in the up-down direction, it is possible to make a difference in the way the light condensing distribution is biased when the heaters 110a and 110b are individually turned on, thereby suppressing the local concentration of the light condensing distribution to one place when the two heaters 110a and 110b are simultaneously turned on.

In addition, in the present embodiment, there is provided a temperature sensor 210, which is a safety sensor that detects a temperature of a region of the upper belt 30 heated by the heaters 110a and 110b and senses whether or not the temperature is equal to or higher than 200° C. that is a threshold. The temperature sensor 210 is disposed near the outside of the reflector 115 because it is necessary to directly detect the temperature of the region (belt area) of the upper belt 30 heated by the heaters 110a and 110b. That is, the temperature sensor 210 serving as a temperature detection unit is disposed at a position where the temperature of the upper belt 30 in a certain region can be detected from the outside of the reflector 115, and detects the temperature of the upper belt 30.

The temperature of 200° C. as the threshold is a temperature set so that the upper belt 30 is not deformed, and is a temperature determined according to the material of the upper belt 30, and thus is not limited thereto. Usually, when the upper belt 30 rotates and the heaters 110a and 110b are temperature-controlled, the temperature sensor 210 maintains a temperature equal to or lower than about 130° C. and does not detect a temperature equal to or higher than 200° C. On the other hand, if the rotation detection sensor 413a fails and the upper belt 30 is driven to stop rotating, the temperature in the vicinity of the detection position of the temperature sensor 210 becomes high because heating can be locally continued. Therefore, by arranging the temperature sensor 210, even in a case where such a failure occurs, a location where the upper belt 30 has the highest temperature can be directly detected by the temperature sensor 210. Therefore, the apparatus can be stopped before the upper belt 30 is damaged due to deformation or the like, making it possible to realize a safer fixing unit.

The reflector 115 is subjected to the above-described mirror finishing or the like to increase the reflection efficiency, but some of the light irradiated by the heaters 110a and 110b is absorbed by the reflector 115 itself, and the temperature of the reflector 115 rises. Therefore, there is a possibility that the temperature of the reflector 115 may eventually rise to about 300° C. On the other hand, the ambient atmosphere is also heated by the reflector 115 heated to a high temperature, and the temperature of the temperature sensor 210 disposed near the reflector 115 may also rise to about 200° C. The heat-resistant temperature of the temperature sensor 210 is about 110° C., and there is possibility that, if the temperature sensor 210 disposed near the reflector 115 becomes too hot, the temperature detection accuracy of the temperature sensor 210 may deteriorate. For this reason, in the present embodiment, in order to suppress the temperature rise of the temperature sensor 210, the following measures are taken.

Position of Temperature Sensor with Respect to Heater

First, in the present embodiment, as illustrated in FIG. 3A, the temperature sensors 210, 220, 230, 240, and 250 serving as temperature detection units are disposed adjacent to the reflectors 115, 125, 135, 145, and 155, respectively. That is, the temperature sensor 210 is disposed adjacent to the reflector 115, the temperature sensor 220 is disposed adjacent to the reflector 125, the temperature sensor 230 is disposed adjacent to the reflector 135, the temperature sensor 240 is disposed adjacent to the reflector 145, and the temperature sensor 250 is disposed adjacent to the reflector 155. A detection window is formed in each of the reflectors 115, 125, 135, 145, and 155 so that each of the temperature sensors 210, 220, 230, 240, and 250 can detect the temperature of the upper belt 30 or the lower belt 40 in such a manner as not to be in contact with the belt the upper belt 30 or the lower belt 40. The detection window is, for example, an opening or a notch, and is formed such that the detection surface of each temperature sensor faces the belt in an oblique direction with respect to the surface of the belt.

Further, the temperature sensor 210 is disposed at a position closer to the heater 110b than to the heater 110a, the heater 110b having a power smaller than that of the heater 110a. That is, in the present embodiment, the temperature sensor 210 is disposed on a side surface close to the heater 110b among the side surfaces of the reflector 115. Since the input power of the heater 110b is smaller than that of the heater 110a, the temperature rise of the side surface of the reflector 115 close to the heater 110b is suppressed. Therefore, by arranging the temperature sensor 210 near this side surface, the temperature rise of the temperature sensor 210 can be suppressed.

In the present embodiment, the plurality of heating portions 117, 127, and 137 are provided in the upper belt unit 10. Therefore, the temperature sensor 210 serving as a temperature detection unit provided in the heating portion 117 and the temperature sensor 220 provided in the heating portion 127 are both disposed between the reflector 115 and the reflector 125. In addition, the temperature sensors 210 and 220 are disposed near the side surfaces of the reflectors 115 and 125 close to the heaters 110b and 120b having a small power, respectively.

This will be described in detail. First, the reflector 115 serving as a first reflecting member of the heating portion 117 reflects radiant heat of the heaters 110a and 110b serving as a first heater and a second heater toward a first region of the upper belt 30. The temperature sensor 210 serving as a first temperature detection unit is disposed at a position where the temperature of the upper belt 30 in the first region can be detected. On the other hand, the heater 120a serving as a third heater and the heater 120b serving as a fourth heater of the heating portion 127 are disposed not to be in contact with the upper belt 30 to heat the upper belt 30 by radiating heat. The heater 120b has a power smaller than that of the heater 120a. The heaters 120a and 120b are disposed inside the reflector 125 serving as a second reflecting member, and reflect radiant heat of the heaters 120a and 120b toward a second region of the upper belt 30. The temperature sensor 220 serving as a second temperature detection unit is disposed at a position where the temperature of the upper belt 30 in the second region can be detected from the outside of the reflector 125, and detects the temperature of the upper belt 30.

In such a configuration, the temperature sensor 210 of the heating portion 117 is disposed between the reflector 115 and the reflector 125 in the rotation direction of the upper belt 30, and at a position closer to the heater 110b than to the heater 110a and closer to the heater 120b than to the heater 120a. The temperature sensor 220 of the heating portion 127 is disposed between the reflector 115 and the reflector 125 in the rotation direction of the upper belt 30, and at a position closer to the heater 110b than to the heater 110a and closer to the heater 120b than to the heater 120a. In other words, the temperature sensors 210 and 220 are disposed between the reflector 115 and the reflector 125, and the heaters 110b and 120b are disposed closer to the temperature sensors 210 and 220, respectively, than to the heaters 110a and 120a in a region between the reflector 115 and the reflector 125. As a result, the temperature rise of the temperature sensors 210 and 220 can be suppressed.

On the other hand, the temperature sensor 230 serving as a temperature detection unit provided in the heating portion 137 is disposed between the reflector 125 and the reflector 135. The temperature sensor 230 is disposed near the side surface of the reflector 135 close to the heater 130b having a power smaller than that of the heater 130a. That is, the temperature sensor 230 is also disposed at a position closer to the heater 130b serving as a second heater than to the heater 130a serving as a first heater, the heater 130b having a power smaller than that of the heater 130a. However, among the heaters 120a and 120b of the heating portion 127 adjacent to the temperature sensor 230, the heater 120a on the high-power side is closer to the temperature sensor 230.

As described above, in the present embodiment, in a case where three or more heating portions are provided, although all the temperature sensors cannot be disposed close to the heaters on the low-power sides, at least the heaters of the heating portions 127 and 137 closest to the temperature sensor 230 are disposed not to be the heaters 120a and 130a on the high-power sides. That is, by using only one of the heaters of the heating portions 127 and 137 close to the temperature sensor 230 as a heater on the low-power side, the temperature rise of the temperature sensor 230 can be suppressed.

Also, in the heating portions 147 and 157 arranged in the lower belt unit 20, the temperature sensors 240 and 250 serving as temperature detection units are arranged similarly to the relationship with the heating portions 117 and 127. That is, the temperature sensor 240 provided in the heating portion 147 and the temperature sensor 250 provided in the heating portion 157 are both disposed between the reflector 145 and the reflector 155. In addition, the temperature sensors 240 and 250 are disposed near the side surfaces of the reflectors 145 and 155 close to the heaters 140b and 150b having powers smaller than those of the heaters 140a and 150a. As a result, the temperature rise of the temperature sensors 240 and 250 can be suppressed.

Air Blow to Space where Temperature Sensor is Disposed

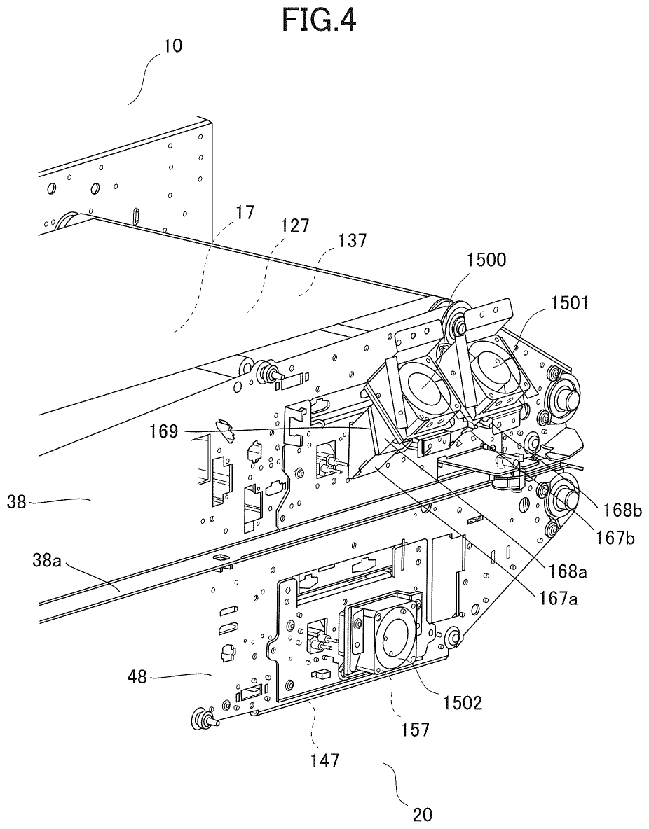

In the present embodiment, in addition to the above-described measures, the temperature rise of the temperature sensors 210, 220, 230, 240, and 250 is suppressed by blowing air using fans 1500, 1501, and 1502 into spaces where the temperature sensors 210, 220, and 230 are disposed. This will be described with reference to FIGS. 3A, 4, and 5. As illustrated in FIG. 4, the fans 1500, 1501, and 1502 that generate the airflow are connected to front plates 38 and 48. In the present embodiment, the fans 1500, 1501, and 1502 are disposed outside the upper belt 30 and the lower belt 40 in the width direction. In addition, the fans 1500, 1501, and 1502 are disposed only on one side of both sides of the upper belt 30 and the lower belt 40 in the width direction. The front plate 38 is a front side plate of the upper belt unit 10. The front plate 38 has a grip portion 38a, so that a user grips the grip portion 38a to perform an operation for processing when the sheet S is jammed or for maintenance of the apparatus as will be described below. The front plate 48 is a front side plate of the lower belt unit 20.

As illustrated in FIG. 3A, the upper belt unit 10 and the lower belt unit 20 have flow path forming portions 161a, 161b, and 161c that form flow paths 160a, 160b, and 160c through which the airflow generated from the fans 1500, 1501, and 1502 flows. The temperature sensors 210, 220, 230, 240, and 250 are disposed in the flow paths 160a, 160b, and 160c. That is, the temperature sensors 210 and 220 are disposed in the flow path 160a, the temperature sensor 230 is disposed in the flow path 160b, and the temperature sensors 240 and 250 are disposed in the flow path 160c. Each of the flow path forming portions 161a, 161b, and 161c may be formed of one member, or may be formed of a plurality of members. Furthermore, parts of the reflectors of the adjacent heating portions may also function as a flow path forming portion. In the present embodiment, each flow path forming portion is configured as follows.

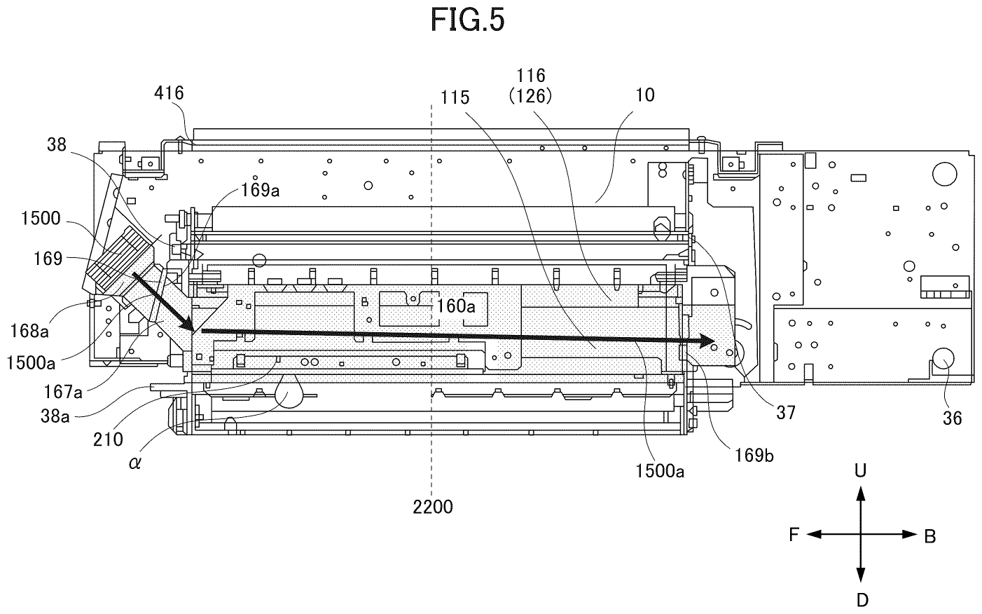

The flow path forming portion 161a forming the flow path 160a includes a front plate 38 serving as a first cover portion, a lower plate 162 serving as a second cover portion, an upper plate 163 serving as a third cover portion, and a rear plate 37 (FIG. 5) as a fourth cover portion. The front plate 38 covers a side upstream of the temperature sensors 210 and 220 in the direction of the airflow flowing through the flow path 160a. The lower plate 162 covers a side close to the surface of the upper belt 30 (the side close to the nip portion N and the lower side in FIGS. 3A and 5) irradiated with the radiant heat of the heaters 110a, 110b, 120a, and 120b with respect to the temperature sensors 210 and 220. The upper plate 163 covers a side opposite to the surface of the upper belt 30 (the side opposite to the nip portion N and the upper side in FIGS. 3A and 5) with respect to the temperature sensors 210 and 220. The rear plate 37 is a rear side plate of the upper belt unit 10, and covers a side downstream of the temperature sensors 210 and 220 in the direction of the airflow flowing through the flow path 160a.

The side surfaces of the reflectors 115 and 125 on the sides close to the temperature sensors 210 and 220, which are parts of the reflectors 115 and 125, constitute the flow path forming portion 161a. The reflectors 115 and 125 and the upper plate 163 are connected by connection plates 116 and 126, respectively, and the connection plates 116 and 126 also constitute the flow path forming portion 161a. The lower plate 162, the upper plate 163, and the connection plates 116 and 126 are disposed along the width direction of the upper belt 30, and are connected to the front plate 38 and the rear plate 37. Therefore, the flow path forming portion 161a is formed by the front plate 38, the rear plate 37, the lower plate 162, the upper plate 163, the reflectors 115 and 125, and the connection plates 116 and 126, and a space surrounded by them is the flow path 160a. Note that the lower plate 162, the upper plate 163, and the connection plates 116 and 126 may not be connected to the rear plate 37.

Similarly, the flow path forming portion 161b forming the flow path 160b includes a front plate 38 serving as a first cover portion, a lower plate 164 serving as a second cover portion, an upper plate 163 serving as a third cover portion, and a rear plate 37 (FIG. 5) serving as a fourth cover portion. The front plate 38 covers a side upstream of the temperature sensor 23 in the direction of the airflow flowing through the flow path 160b. The lower plate 164 covers a side close to the surface of the upper belt 30 (the side close to the nip portion N and the lower side in FIGS. 3A and 5) irradiated with the radiant heat of the heaters 130a and 130b with respect to the temperature sensor 230. The upper plate 163 communicates with the flow path forming portion 161a, and covers a side opposite to the surface of the upper belt 30 (the side opposite to the nip portion N and the upper side in FIGS. 3A and 5) with respect to the temperature sensor 230. The rear plate 37 covers a side downstream of the temperature sensor 230 in the direction of the airflow flowing through the flow path 160b.

The side surfaces of the reflectors 125 and 135 close to the temperature sensor 230, which are parts of the reflectors 125 and 135, constitutes the flow path forming portion 161b. The reflector 135 and the upper plate 163 are connected by a connection plate 136, and the connection plate 136 also constitutes the flow path forming portion 161b. Note that the connection plate 126 described above also constitutes the flow path forming portion 161b. The lower plate 164, the upper plate 163, and the connection plate 136 are disposed along the width direction of the upper belt 30, and are connected to the front plate 38 and the rear plate 37. Therefore, the flow path forming portion 161b is formed by the front plate 38, the rear plate 37, the lower plate 164, the upper plate 163, the reflectors 125 and 135, and the connection plates 126 and 136, and a space surrounded by them is the flow path 160b. Note that the connection plate 136 may not be connected to the rear plate 37. In addition, the connection plate 126 may be omitted, and the flow path 160a and the flow path 160b may communicate with each other between the reflector 125 and the upper plate 163.

Similarly, the flow path forming portion 161c forming the flow path 160c includes a front plate 48 serving as a first cover portion, a lower plate 165 serving as a second cover portion, an upper plate 166 serving as a third cover portion, and a rear plate (not illustrated) serving as a fourth cover portion. The front plate 48 is a front side plate of the lower belt unit 20, and covers a side upstream of the temperature sensors 240 and 250 in the direction of the airflow flowing through the flow path 160c. The lower plate 165 covers a side close to the surface of the lower belt 40 (the side opposite to the nip portion N and the lower side in FIGS. 3A and 5) irradiated with the radiant heat of the heaters 140a, 140b, 150a, and 150b with respect to the temperature sensors 240 and 250. The upper plate 166 covers a side opposite to the surface of the lower belt 40 (the side close to the nip portion N and the upper side in FIGS. 3A and 5) with respect to the temperature sensors 240 and 250. The rear plate is a rear side plate of the lower belt unit 20, and covers a side downstream of the temperature sensors 240 and 250 in the direction of the airflow flowing through the flow path 160c.

The side surfaces of the reflectors 145 and 155 on the sides close to the temperature sensors 240 and 250, which are parts of the reflectors 145 and 155, constitute the flow path forming portion 161c. The reflectors 145 and 155 and the upper plate 166 are connected by connection plates 146 and 156, respectively, and the connection plates 146 and 156 also constitute the flow path forming portion 161c. The lower plate 165, the upper plate 166, and the connection plates 146 and 156 are disposed along the width direction of the lower belt 40, and are connected to the front plate 48 and the rear plate. Therefore, the flow path forming portion 161c is formed by the front plate 48, the rear plate, the lower plate 165, the upper plate 166, the reflectors 145 and 155, and the connection plates 146 and 156, and a space surrounded by them is the flow path 160c. Note that the lower plate 165, the upper plate 166, and the connection plates 146 and 156 may not be connected to the rear plate.

The fans 1500, 1501, and 1502 are connected to the front plates 38 and 48. The fan 1500 is connected to the flow path forming portion 161a to blow air to the flow path 160a. The fan 1501 is connected to the flow path forming portion 161b to blow air to the flow path 160b. The fan 1502 is connected to the flow path forming portion 161c to blow air to the flow path 160c.

A first flow path inlet unit 167a serving as a second duct portion is connected to the upstream side (front side) of the flow path forming portion 161a in the direction in which the airflow flows, that is, the front plate 38. The first flow path inlet unit 167a is connected to a second flow path inlet unit 168a serving as a first duct portion provided in the upper frame 416. The fan 1500 is connected to the second flow path inlet unit 168a. The second flow path inlet unit 168a is connected to the fan 1500 to allow the airflow generated from the fan 1500 to flow thereinto. The first flow path inlet unit 167a is connected to the front plate 38 and the second flow path inlet unit 168a to send the airflow generated from the fan 1550 to the inside of the flow path forming portion 161a.

Therefore, as illustrated in FIG. 5, the airflow generated by the fan 1500 is sent to the inside of the flow path forming portion 161a via the second flow path inlet unit 168a and the first flow path inlet unit 167a, and flows through the flow path 160a as indicated by an arrow 1500a. On the other hand, a flow path outlet 169b is provided on the downstream side (rear side) of the flow path forming portion 161a in the direction in which the airflow flows, that is, the rear plate 37, so that the air having passed through the flow path 160a can be discharged to the outside of the upper belt unit 10. In addition, at least a part of each of the temperature sensors 210 and 220 is disposed inside the flow path forming portion 161a.

Similarly, a first flow path inlet unit 167b serving as a second duct portion is connected to the upstream side (front side) of the flow path forming portion 161b in the direction in which the airflow flows, that is, the front plate 38. The first flow path inlet unit 167b is connected to a second flow path inlet unit 168b serving as a first duct portion provided in the upper frame 416. The fan 1501 is connected to the second flow path inlet unit 168b. The configuration in which the airflow flows from the fan 1501 to the inside of the flow path forming portion 161b is the same as the configuration in which the airflow flows from the fan 1500 to the inside of the flow path forming portion 161a. In the upper belt unit 10, the flow path inlet configuration connected to each of the fans 1500 and 1501 includes two members. This is because the first flow path inlet units 167a and 167b and the second flow path inlet units 168a and 168b can be separated from each other at the time of maintenance of the apparatus or the like as will be described in detail below.

On the other hand, in the lower belt unit 20, the fan 1502 is connected to the upstream side (front side) of the flow path forming portion 161b in the direction in which the airflow flows, that is, the front plate 48, directly or via a duct. The flow path inlet configuration connected to the fan 1502 in the lower belt unit 20 may also include two members similarly to the flow path inlet configuration connected to each of the fans 1500 and 1501 in the upper belt unit 10.

The temperature sensor 210 that detects the temperature of the upper belt 30 heated by the heaters 110a and 110b is located between the reflector 115 and the reflector 125, and is disposed at a position close to the fan 1500 to be described below with respect to the center 2200 of the upper belt 30 in the width direction. That is, the temperature sensor 210 is disposed upstream of the center 2200 of the upper belt 30 in the width direction with respect to the direction in which the airflow flows by the fan 1500. FIG. 5 illustrates a region (detection region) a of the upper belt 30 detected by the temperature sensor 210. In the present embodiment, the detection region a is also located upstream of the center 2200 of the upper belt 30 in the width direction with respect to the direction in which the airflow flows by the fan 1500 to be described below. Note that the same applies to the other temperature sensors 220, 230, 240, and 250.

As described above, the temperature sensors 210, 220, 230, 240, and 250 are disposed in the flow paths 160a, 160b, and 160c. The fans 1500, 1501, and 1502 take in air and send the air into the flow path forming portions 161a, 161b, and 161c to form air flows in the flow paths 160a, 160b, and 160c, respectively. Then, the temperature sensors 210, 220, 230, 240, and 250 are cooled by the formed air flows. Therefore, the temperature rise of the temperature sensors 210, 220, 230, 240, and 250 can be suppressed.

Further, when the plurality of heating portions are arranged side by side in the rotation direction of the upper belt 30 or the lower belt 40 as in the present embodiment, heat is supplied to the temperature sensors from the adjacent reflectors and the temperatures of the temperature sensors rise. Therefore, as described above, by arranging the two temperature sensors 210 and 220 or the two temperature sensors 240 and 250 in one flow path 160a or one flow path 160c, it is possible to efficiently cool the temperature sensors with a small number of fans.

Note that, although the temperature sensors are configured as described above in order to minimize the number of fans used and to reduce the cross-sectional size of the apparatus, the arrangement of the temperature sensors and the number of fans and flow paths are not limited to those described above. For example, a flow path may be formed for each temperature sensor. For example, the heating portion 147 or the heating portion 157, or both of the temperature sensors 240 and 250 may be disposed on the opposite side of what has been described above (outside the reflector on the opposite left or right side with respect to the position illustrated in FIG. 3A), and a fan and a flow path may be added. Furthermore, the heating portion 117 or the heating portion 137, or both of the temperature sensors 210 and 230 may be disposed on opposite side, and a fan and a flow path may be added.

As described above, by appropriately positioning the temperature sensors with respect to the heaters and blowing air to the spaces where the temperature sensors are disposed, for example, the amount of heat received by the reflector 115 from the heaters 110a and 110b is reduced, and the temperature sensor 210 is cooled by air flows, thereby making it possible to suppress the temperature of the temperature sensor 210 to about 95° C. As a result, the temperature sensor 210 can detect a temperature with high accuracy. The same applies to the other temperature sensors 220, 230, 240, and 250.

In the above description, the fans 1500, 1501, and 1502 are fans disposed on the upstream sides of the flow paths 160a, 160b, and 160c in the direction in which the airflow flows to supply air to the flow paths 160a, 160b, and 160c. However, at least one of the fans 1500, 1501, and 1502 may be a fan that is disposed on the downstream side of the corresponding flow path 160a, 160b, or 160c in the direction in which the airflow flows to exhaust air from the flow path. In addition, at least one of the flow paths may be provided with both a fan for supplying air and a fan for exhausting air.

### Regarding Jam Processing and Maintenance

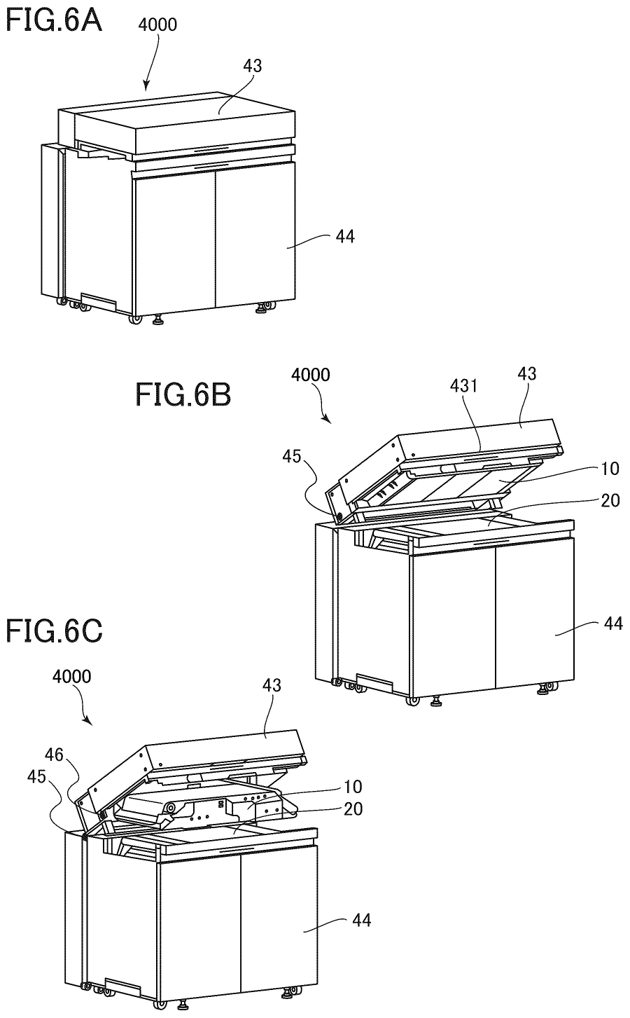

Next, jam processing and maintenance in the fixing module 4000 according to the present embodiment will be described with reference to FIGS. 6A to 6C. In a case where a sheet jam or a conveyance slip occurs in the sheet conveyance path 4100a (FIG. 1) and the conveyance timing deviates from a predetermined conveyance timing, the apparatus detects the jam. In this case, the sheet S remaining in the sheet conveyance path 4100a is automatically discharged onto a purge tray, but when the remaining sheet cannot be discharged onto the purge tray, the user needs to remove the remaining sheet. The sheet S is conveyed while being nipped by the nip portion N between the upper belt unit 10 and the lower belt unit 20. However, if the sheet S remains in the nip portion N when a jam occurs, the user opens the nip portion N and removes the remaining sheet.

Therefore, one of the upper belt unit 10 and the lower belt unit 20 is movable with respect to the other belt unit between a nip position where the nip portion N is formed by the upper belt 30 and the lower belt 40 and a separated position where the upper belt 30 and the lower belt 40 are further spaced apart from each other than at the nip position. In the present embodiment, the upper belt unit 10 is movable with respect to the lower belt unit 20 between the nip position and the separated position. Hereinafter, this will be described in detail.

As illustrated in FIGS. 6A to 6C, the fixing module 4000 includes an upper door unit 43 serving as a casing or a first casing openable in the upward direction U. The upper belt unit 10 of the fixing belt unit 4100 can be accommodated in the upper door unit 43, and the upper door unit 43 can be opened in the upward direction U integrally with the upper belt unit 10. The upper door unit 43 is pivotably coupled to an apparatus body 44 serving as a second casing by a support shaft 45 provided on a side toward the rearward direction B of the apparatus body 44. The support shaft 45 serving as a second pivot supporting portion is provided on the rear side of the apparatus body 44 in the width direction (front-rear direction), and is provided along the sheet conveyance direction (left-right direction). The upper door unit 43 is provided to be pivotable about support shaft 45 with respect to apparatus body 44.

The upper door unit 43 has a handle 431 on a side toward the forward direction F of the apparatus body 44, and is pivoted and opened by pulling up the handle 431 in the upward direction U. The upper door unit 43 is pivotable with respect to apparatus body 44 between a closed position (FIG. 6A) and an open position (FIG. 6B). The closed position is a nip position where the nip portion N is formed by the upper belt 30 and the lower belt 40, and the open position is a separated position where the upper belt 30 and the lower belt 40 are further spaced apart from each other than at the nip position. In the present embodiment, the upper door unit 43 is constituted by a top plate or a side plate, and has a function as an upper cover of the apparatus body 44.

When a jam occurs, the user pulls up the handle 431 of the upper door unit 43 to open the upper door unit 43 upward to the separated position, and the sheet S remaining in the apparatus body 44 can be removed from the front surface of the apparatus. In the present embodiment, in order to improve operability when the user opens and closes the upper door unit 43, a gas spring (not illustrated) is provided, so that the upper door unit 43 is biased toward the open position by the gas spring to maintain the upper door unit 43 at the open position. When the apparatus is used, the upper door unit 43 is maintained at the closed position by its own weight, and the nip portion N is formed as described above.

The upper belt unit 10 is supported by a support shaft 46 in such a manner as to pivot between a first position and a second position with respect to the upper door unit 43. As illustrated in FIG. 6C, the support shaft 46 serving as a pivot supporting portion or a first pivot supporting portion is provided on the rear side of the upper door unit 43 in the width direction (front-rear direction), and is provided along the sheet conveyance direction (left-right direction). In addition, the first position (upper storage position) is a position where the upper belt unit 10 is accommodated in the upper door unit 43 (FIG. 6B). The second position (maintenance position) is a position where at least a part of the upper belt unit 10 is exposed to the outside of the upper door unit 43 more than the first position (FIG. 6C). The upper belt unit 10 is movable from the first position to the second position at the above-described separated position.

When the apparatus is used, the upper belt unit 10 is fixed near the front side of the upper door unit 43 by a holding member such as a screw (not illustrated) to be held at the upper storage position. When the maintenance of the upper belt unit 10 is performed, while the upper door unit 43 is at the open position, the upper belt unit 10 is moved downward about the support shaft 46 from the upper door unit 43 to the maintenance position, for example, by gripping the grip portion 38a provided on the front plate 38. The maintenance position is, for example, a state where the upper belt 30 to/from the upper belt unit 10 is allowed to be attached to or detached from the upper belt unit 10.

As described above, in the upper belt unit 10, the flow path inlet configuration connected to each of the fans 1500 and 1501 includes two members. That is, the flow path inlet configuration includes the first flow path inlet unit 167a or 167b and the second flow path inlet unit 168a or 168b. Here, if all the flow path inlet configurations connected to the fans 1500 and 1501 are fixed to the upper frame 416 of the upper belt unit 10, it is necessary to move downward the upper belt unit 10 including the fans 1500 and 1501 at the time of maintenance (FIG. 6C), which may cause an increase in size of the apparatus or a deterioration in maintainability of the apparatus.

For this reason, in the present embodiment, as illustrated in FIG. 5, the fans 1500 and 1501 and the second flow path inlet units 168a and 168b are fixed to the upper frame 416, and the second flow path inlet units 168a and 168b and the first flow path inlet units 167a and 167b are configured to be separable by connecting portions 169 at the time of maintenance. That is, the connecting portions 169 can connect the second flow path inlet units 168a and 168b and the first flow path inlet units 167a and 167b at the upper storage position, and separate the second flow path inlet units 168a and 168b and the first flow path inlet units 167a and 167b when the upper belt unit 10 moves from the upper storage position to the maintenance position. As a result, at the time of maintenance, the upper belt unit 10 can be moved downward from the upper storage position while the fans 1500 and 1501 are left in the upper door unit 43.

In the present embodiment, joining surfaces 169a between the second flow path inlet units 168a and 168b and the first flow path inlet units 167a and 167b are inclined in a direction toward the upstream side of the direction of the airflow flowing through the flow paths 160a and 160b as approaching the first stretched surface 30a with respect to the direction (up-down direction) orthogonal to the first stretched surface 30a of the upper belt 30 (the sheet conveyance direction in FIG. 2) at the upper storage position. That is, in FIG. 5, the joining surface 169a of the connecting portion 169 is inclined frontward as it extends downward. By forming the joining surface 169a as an inclined surface in this manner, even if the positions of the second flow path inlet units 168a and 168b and the first flow path inlet units 167a and 167b are slightly shifted at the time of joint, this shift in the inclined direction can be absorbed, and the joint can be stably performed. Note that a sealing member or the like may be provided on the joining surface 169a to enhance sealability.

In the present embodiment, since the lower belt unit 20 does not need to be divided for maintenance as described above, the fan 1502 is directly attached to the front plate 48 of the lower belt unit 20.

The fans 1500 and 1501 are disposed obliquely above the intake ports of the second flow path inlet units 168a and 168b, and form oblique air flows downward. Some of the air blown by the fans 1500 and 1501 leaks out from parts (for example, front end portions of the reflectors 115 and 125) of the flow path forming portions 161a and 161b and hits the lower portion and the side surface portion of the front plate 38 and the grip portion 38a. As a result, it is possible to lower the temperature of the grip portion 38a that is gripped to perform an operation for processing when the sheet S is jammed or for maintenance of the apparatus.

### Configuration for Controlling Heater of Upper Belt Unit

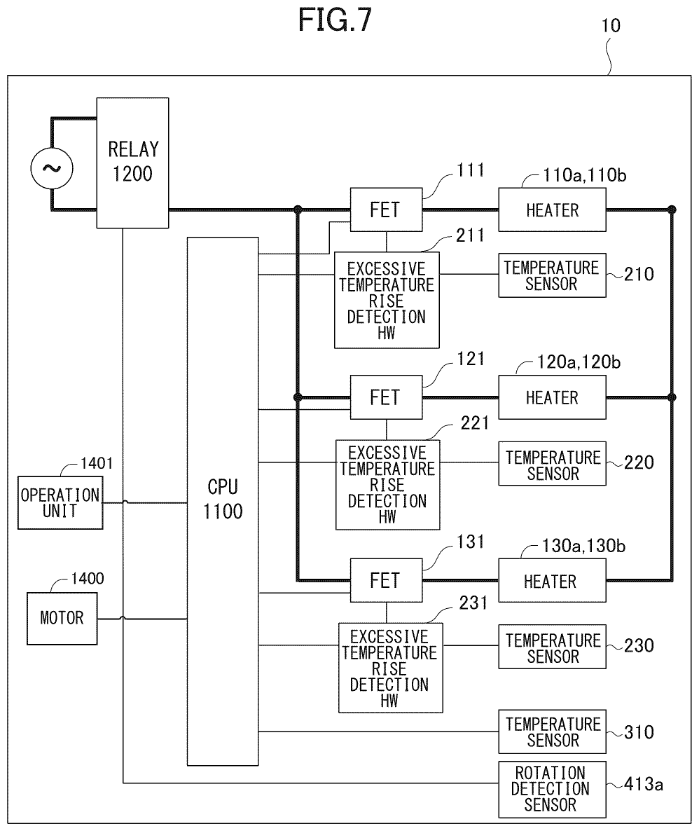

Next, a configuration for controlling heaters 110a, 110b, 120a, 120b, 130a, and 130b included in upper belt unit 10 will be described with reference to FIG. 7. FIG. 7 is a hardware block diagram of the upper belt unit 10 according to the present embodiment. The configuration for controlling the upper belt unit 10 includes a central processing unit (CPU) 1100 serving as a control unit, a relay 1200, a power source 1300 serving as a power supply unit, a motor 1400 serving as a driving unit, field effect transistors (FETs) 111, 121, and 131 serving as voltage adjustment units, excessive temperature rise detection hardware (HWs) 211, 221, and 231 serving as threshold determination units, heaters 110a, 110b, 120a, 120b, 130a, and 130b, protection temperature sensors 210, 220, and 230, a temperature sensor 310 for temperature-adjustment, and a rotation detection sensor 413a.

The CPU 1100 controls the driving of the motor 1400. The motor 1400 is a motor that drives the upper belt 30 to rotate, and drives the driving roller 610 via a drive transmission path (not illustrated) in the present embodiment. The motor 1400 starts or stops driving in accordance with an instruction from the CPU 1100.

The CPU 1100 drives the FETs 111, 121, and 131 by controlling the FETs 111, 121, and 131 to be turned on/off to control power supplied to the heaters 110a, 110b, 120a, 120b, 130a, and 130b. The power is supplied from the power source 1300 to each of the heaters 110a, 110b, 120a, 120b, 130a, 130b. The FETs 111, 121, and 131 are disposed between the power source 1300 and the heaters 110a, 110b, 120a, 120b, 130a, and 130b, and adjust the voltage applied from the power source 1300 to the respective heaters based on the control by the CPU 1100.

The CPU 1100 adjusts power to be supplied to the heaters 110a, 110b, 120a, 120b, 130a, and 130b by feeding back temperature information from the temperature sensor 310 for temperature-adjustment. That is, the CPU 1100 performs temperature adjustment control of the upper belt 30 by driving the FETs 111, 121, and 131 based on the temperature (detection result) detected by the temperature sensor 310.

The excessive temperature rise detection HWs 211, 221, and 231 can switch the FETs 111, 121, and 131 between an energization state in which the power source 1300 energizes the heaters 110a, 110b, 120a, 120b, 130a, and 130b, and a cutoff state in which the power source 1300 and the heaters 110a, 110b, 120a, 120b, 130a, and 130b are cut off. The excessive temperature rise detection HWs 211, 221, and 231 are switched from the energization state to the cutoff state when the temperatures detected by the temperature sensors 210, 220, and 230 becomes equal to or higher than a threshold. That is, when it is detected that the temperatures of the temperature sensors 210, 220, and 230 are equal to or higher than the threshold, the excessive temperature rise detection HWs 211, 221, and 231 stop driving the FETs 111, 121, and 131. The excessive temperature rise threshold is a temperature set to prevent deformation depending on the material of the belt, and is set to 200° C. in the present embodiment, but is not limited thereto.

When any of the excessive temperature rise detection HWs 211, 221, and 231 detects 200° C. or higher, the control of the corresponding one of the FETs 111, 121, and 131 is stopped. For example, when the temperature of the temperature sensor 210 is detected by the excessive temperature rise detection HW 211, the control of the FET 111 is stopped, but the control of the other FETs 121 and 131 is not stopped by the hardware circuit. The CPU 1100 detects an interrupt signal of the excessive temperature rise detection HW 211 and stops the FETs 121 and 131 by software. Although the FET is stopped by the CPU in the above description, the FET may be stopped by the hardware circuit.

The rotation detection sensor 413a detects the stop of the rotation of the upper belt 30, so that the heating of the heaters 110a, 110b, 120a, 120b, 130a, and 130b is stopped by cutting off the relay 1200. An operation unit 1401 serving as a notification unit is connected to the CPU 1100. The operation unit 1401 is for operating an inkjet recording apparatus 1, and is, for example, an operation panel having a touch panel capable of inputting and displaying information. A physical button such as a start button may be provided in addition to the touch panel in the operation unit 1401. In the present embodiment, a display unit included in the operation unit 1401 has a function of notifying the user of various types of information such as error information. Examples of the error information include a stop due to an excessive temperature rise of the upper belt 30. Furthermore, the CPU 1100 may notify an external terminal such as a personal computer connected to the inkjet recording apparatus 1 of various types of information such as error information of the fixing belt unit 4100. In this case, the CPU 1100 functions as a notification unit.

### Fixing Control of Upper Belt Unit

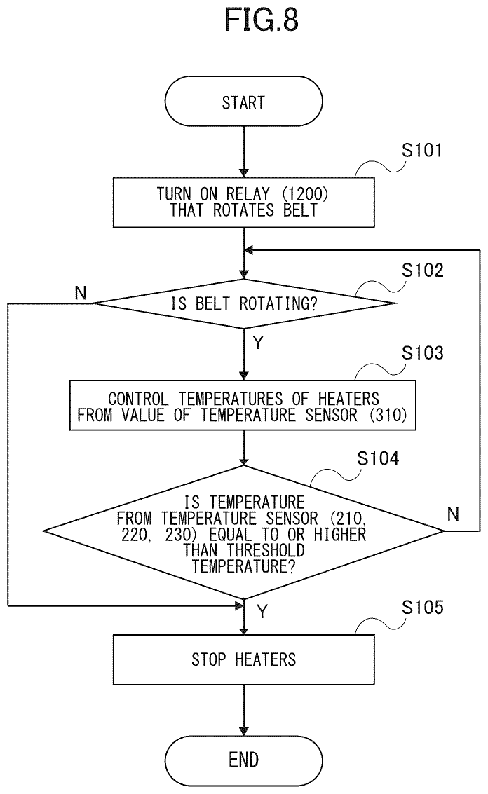

Next, fixing control of the upper belt unit 10 will be described with reference to FIG. 8. When the fixing control is started, the CPU 1100 controls the motor 1400 of the upper belt 30 to rotate the upper belt 30. In addition, the CPU 1100 turns on the relay 1200 (S101). The CPU 1100 causes the rotation detection sensor 413a to determine whether the upper belt 30 is rotating (S102). The CPU 1100 proceeds to S103 when determining that the upper belt 30 is rotating (Y in S102), and proceeds to S105 when determining that the upper belt 30 is not rotating (N in S102).

If Y in S102, the CPU 1100 controls temperatures of the heaters 110a, 110b, 120a, 120b, 130a, and 130b from a temperature value read from the temperature sensor 310 (S103). In the present embodiment, the CPU 1100 controls the heaters 110a, 110b, 120a, 120b, 130a, and 130b by controlling the temperatures of the FETs 111, 121, and 131 using a duty width of a PWM control signal.

Next, the CPU 1100 determines whether the value of the temperature read from each of the temperature sensors 210, 220, and 230 is equal to or higher than the threshold temperature (S104). When the value of at least one of the temperature sensors 210, 220, and 230 is equal to or higher than the threshold temperature (Y in S104), the CPU 1100 proceeds to S105. On the other hand, when the value of the temperature read from the temperature sensor 210, 220, or 230 is lower than the threshold temperature (N in S104), the CPU 1100 proceeds to S102. In S105, the CPU 1100 turns off the FETs 111, 121, and 131 to stop the heaters 110a, 110b, 120a, 120b, 130a, and 130b.

When the rotation detection sensor 413a fails and the upper belt 30 is driven to stop rotating, it may be determined in S102 that the upper belt 30 is rotating even if the rotation of the upper belt 30 is stopped. In this case, the CPU 1100 proceeds to S103. In S103, the CPU 1100 controls temperatures of the heaters 110a, 110b, 120a, 120b, 130a, and 130b from a temperature value read from the temperature sensor 310. Since the upper belt 30 is not rotating, only the temperatures of the portions of the upper belt 30 facing the heating portions 117, 127, and 137 rises while the value of the temperature read by the temperature sensor 310 remains substantially unchanged.

As a result, in S104, the value of the temperature read from the temperature sensor 210, 220, or 230 becomes equal to or higher than the threshold temperature, and the CPU 1100 proceeds to S105. In S105, the CPU 1100 turns off the FETs 111, 121, and 131 to stop the heaters 110a, 110b, 120a, 120b, 130a, and 130b. Therefore, the driving of the heaters can be stopped before the temperature of the upper belt 30 becomes an excessively rising temperature exceeding the threshold temperature.

### Configuration of Temperature Sensor

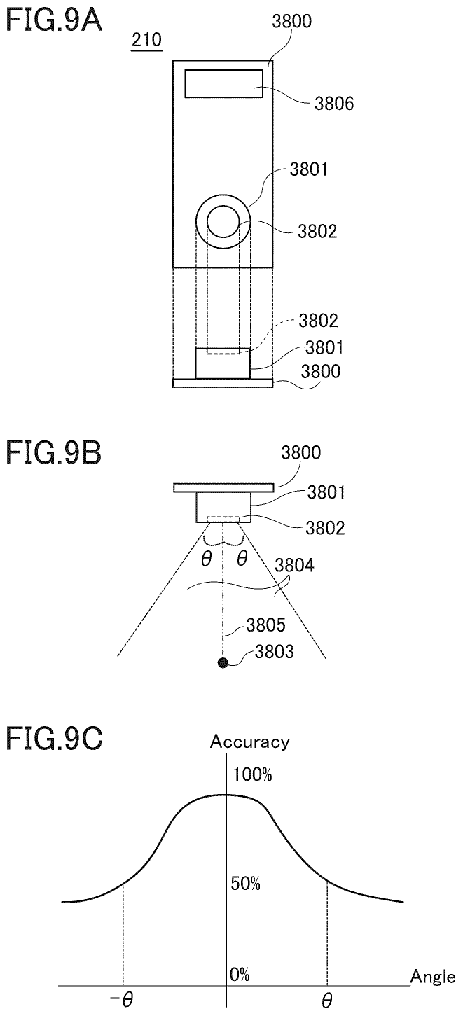

Next, the configurations of the temperature sensors 210, 220, and 230 will be described with reference to FIGS. 9A to 9C. Since the configurations of the temperature sensors 210, 220, and 230 are the same, the temperature sensor 210 will be described below as a representative. FIG. 9A is an external shape view of the temperature sensor 210, in which the upper diagram is a plan view and the lower diagram is a side view. FIGS. 9B and 9C are diagrams for explaining a viewing angle of the temperature sensor 210.

A sensor module 3801 is a package in which the sensor module is incorporated, is mounted on a substrate 3800, and has a detection window 3802 at an upper portion. The temperature sensor 210 enables contactless temperature detection by absorbing infrared rays emitted from a measurement target through the detection window 3802 and converting the absorbed infrared energy into an electric signal. In addition, the temperature sensor 210 can output a result detected by the sensor module 3801 from a connector 3806. In the present embodiment, the sensor module 3801 that actually detects a temperature is disposed at the most end of the substrate among the components mounted in the substrate 3800.

FIG. 9B is a diagram schematically illustrating a viewing angle of the temperature sensor 210. The detection window 3802 not only allows infrared rays to pass into the sensor module 3801 but also serves as a lens. That is, the temperature sensor 210 has a fixed viewing angle 3804, and detects a temperature of a measurement target 3803 within the viewing angle 3804 in a non-contact manner.

FIG. 9C is a diagram for explaining the definition of the viewing angle 3804. The temperature measurement accuracy when the measurement target 3803 is present on the center line 3805 of the viewing angle 3804 is set to 100%. Next, the measurement target 3803 is moved from the center line 3805 without changing the distance from the temperature sensor 210. An angle θ formed by the measurement target 3803 and the center line 3805 when the temperature measurement accuracy decreases to 50% due to the movement is defined as the viewing angle 3804. Note that the value 50% in the present embodiment is merely an example, and the value is not limited to 50%.

### Configuration of Heater

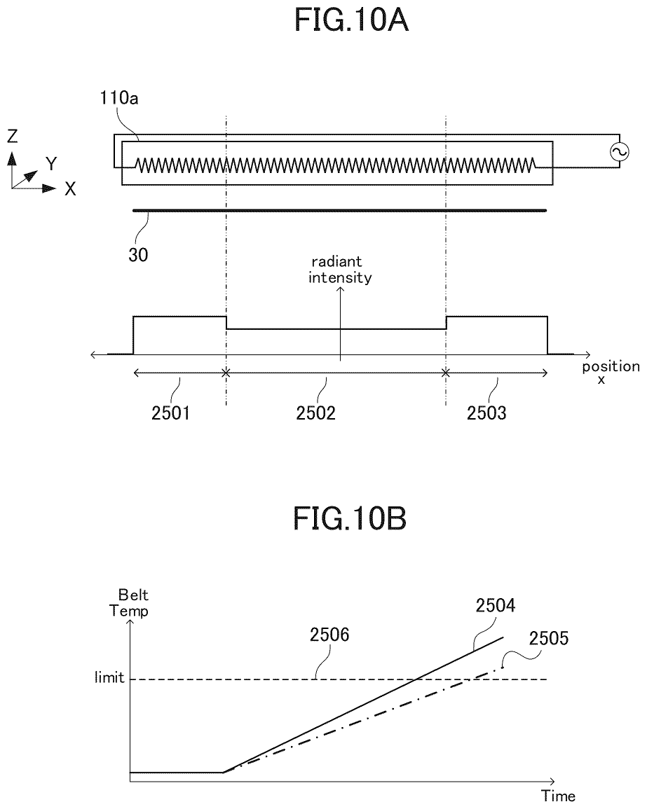

Next, the configurations of heaters 110a, 110b, 120a, 120b, 130a, and 130b will be described with reference to FIGS. 10A and 10B. In the present embodiment, concerning the heaters 110a, 110b, 120a, 120b, 130a, and 130b, the two heaters in each heating portion are different only in power, and are identical in distribute light. Therefore, the heater 110a will be described below as a representative. FIG. 10A is a schematic view of the heater 110a and the upper belt 30 as viewed from the upstream side toward the downstream side in the sheet conveyance direction, and a graph illustrating a radiant intensity of the heater 110a at a position in a belt width direction. The belt width direction is a direction orthogonal to the sheet conveyance direction, and is indicated as an x axis in the drawing. In addition, the sheet conveyance direction is indicated as a y axis, and the height direction is indicated as a z axis. In the present embodiment, the heater 110a distributes light to have a higher radiant intensity in end regions 2501 and 2503 in the belt width direction than in a central region 2502 in the belt width direction, thereby suppressing uneven heating in the belt width direction.

FIG. 10B is a graph illustrating a relationship between a heating time and a temperature of the upper belt 30 when the upper belt 30 is continuously heated by the heaters. The horizontal axis represents a time, and the vertical axis represents a temperature of the upper belt 30. A graph 2504 indicates a temperature rise in the end regions 2501 and 2503 in the belt width direction, and a graph 2505 indicates a temperature rise in the central region 2502 in the belt width direction. Since light is distributed in such a manner that the radiant intensity is higher in the end regions 2501 and 2503 than in the central region 2502, the temperature rises with a larger inclination in the graph 2504. A broken line 2506 illustrated in the drawing indicates a limit temperature set not to deform the belt, which is a temperature determined depending on the material of the belt. Therefore, the threshold for excessive temperature rise detection is set so that the belt does not exceed the limit temperature indicated by the broken line 2506. Note that the heaters 110a, 110b, 120a, 120b, 130a, and 130b have the same configuration, but may have different configurations. For example, one of the two heaters in each heating portion may distribute light as described above, and the other heater may distribute light with a flat radiant intensity in the belt width direction. Alternatively, both the two heaters may distribute light with a flat radiant intensity. Alternatively, the radiant intensities of the two heaters may be flat with different lengths.

### Temperature Distribution

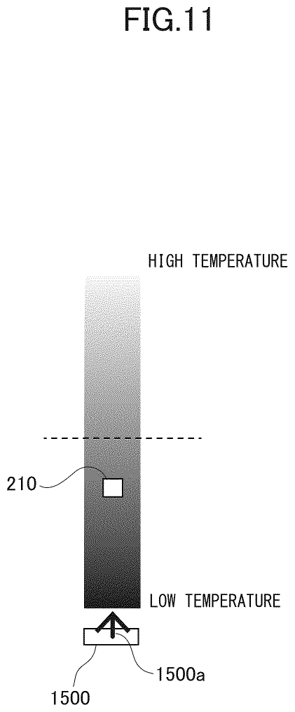

Next, distributions of ambient temperatures in the flow paths where the temperature sensors 210, 220, and 230 are located will be described. As described above, the temperature sensors 210 and 220 are disposed between the reflector 115 and the reflector 125, and the temperature sensor 230 is disposed between the reflector 125 and the reflector 135. FIG. 11 illustrates an ambient temperature distribution between the reflector 115 and the reflector 125. As described with reference to FIG. 5, since the air flow is formed between the reflector 115 and the reflector 125 in a direction indicated by an arrow 1500a from the fan 1500, outside air is blown to a place near the fan 1500. Therefore, the ambient temperature near the fan 1500 decreases. Every time air moves in the direction indicated by the arrow 1500a, the air is warmed by the heat of the heaters 110a and 110b and the heaters 120a and 120b transmitted through the reflectors 115 and 125, so that the ambient temperature increases at a position far from the fan 1500.

Therefore, in the present embodiment, as described above, the temperature sensor 210 is disposed upstream of the center 2200 of the upper belt 30 in the width direction with respect to the direction in which the airflow flows by the fan 1500. As a result, low-temperature air can hit the temperature sensor 210, and the temperature sensor 210 can be efficiently cooled. The same applies to other temperature sensors. As described above, in the present embodiment, in the system in which the belt is directly heated using the reflectors and the heaters, and in the configuration in which the temperature of the belt is detected using the non-contact temperature sensors, since the temperature sensors are disposed in the flow paths through which the air flows, it is possible to suppress the temperature sensor from becoming too hot. As a result, it is possible to suppress a deterioration in quality of a product and a deterioration in safety of the apparatus when the temperature sensor is used as a sensor that detects an excessive temperature rise, which are caused by a deterioration in detection accuracy of the temperature sensor.

### Second Embodiment

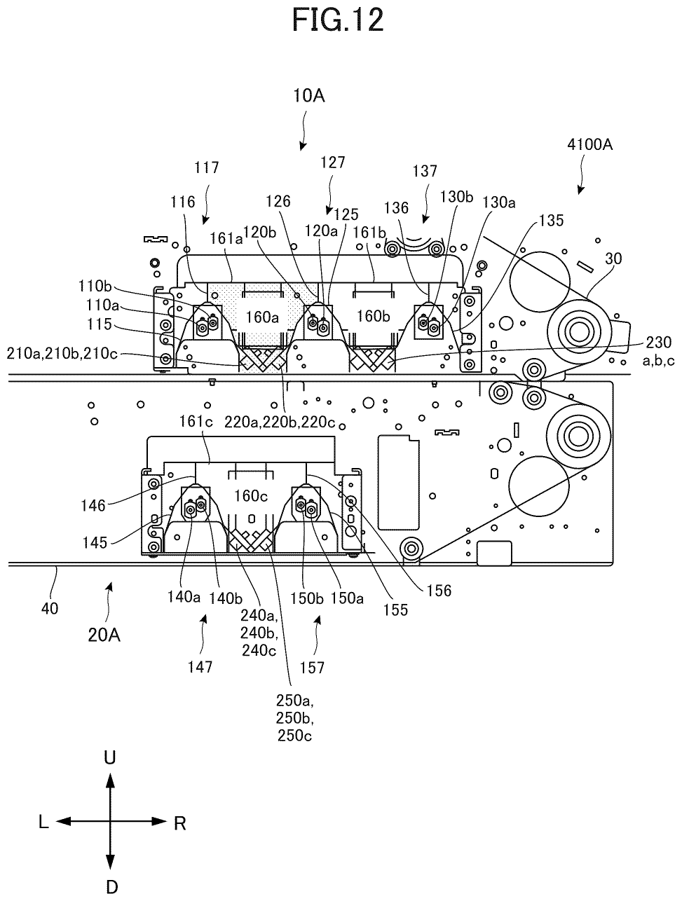

A second embodiment will be described with reference to FIGS. 12 to 14. In the first embodiment described above, the configuration in which one temperature sensor for detecting the temperature immediately below each heater is provided for each heater has been described. On the other hand, in the present embodiment, temperature detection is performed by a plurality of the temperature sensors for each heater. Since the other configurations and operations are similar to those in the first embodiment described above, the same configurations are denoted by the same reference signs, description and illustration thereof are omitted or simplified, and hereinafter, differences from the first embodiment will be mainly described.

FIG. 12 is an enlarged cross-sectional view illustrating a part of an upper belt unit 10A and a part of a lower belt unit 20A of a fixing belt unit 4100A in an ink jet recording apparatus according to the present embodiment. The difference from the fixing belt unit 4100 (FIG. 2) according to the first embodiment is that there are three temperature sensors (temperature sensors 210a, 210b, and 210c, 220a, 220b, and 220c, 230a, 230b, and 230c, 240a, 240b, and 240c, or 250a, 250b, and 250c) for each heater that detect the belt temperature immediately below each heater (a region irradiated with radiant heat from the heater). That is, in the present embodiment, a plurality of the temperature sensors (temperature sensors 210a, 210b, and 210c) that detect the temperature of the upper belt 30 immediately below the heaters 110a and 110b are disposed along the width direction. Similarly, a plurality of the temperature sensors (temperature sensors 220a, 220b, and 220c, 230a, 230b, and 230c, 240a, 240b, and 240c, or 250a, 250b, and 250c) that detect the temperature of the upper belt 30 or the lower belt 40 immediately below each of the other heaters are arranged along the width direction. The other configurations are the same as those of the first embodiment.

### Configuration for Controlling Heater of Upper Belt Unit

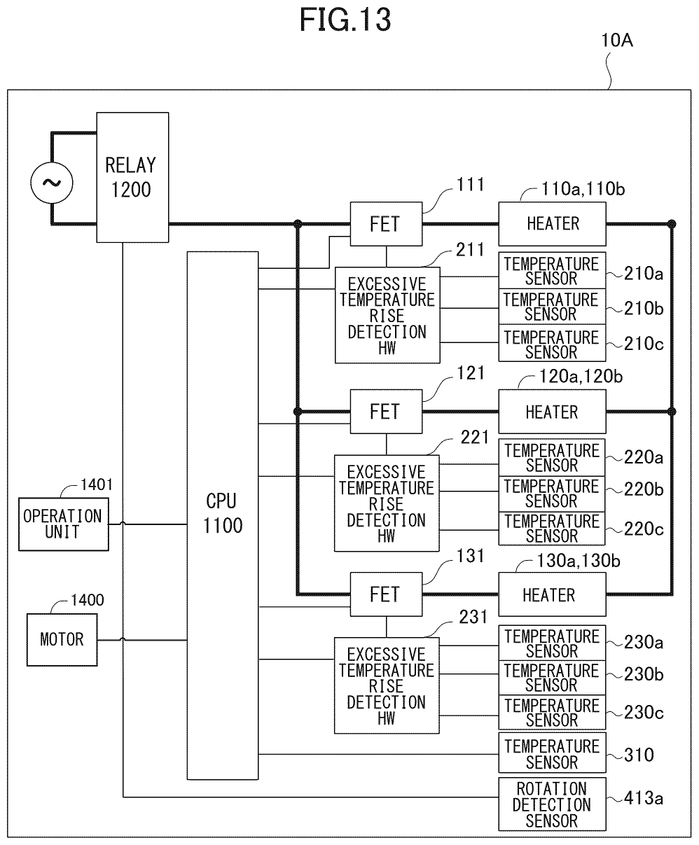

FIG. 13 is a hardware block diagram of the upper belt unit 10A according to the present embodiment. Three temperature sensors for detecting the belt temperature immediately below each heater are provided for each heater. In addition, the excessive temperature rise detection HWs 211, 221, and 231 are changed, from the block diagram of the first embodiment (FIG. 7), such that power supply to the heater can be controlled based on inputs from the three temperature sensors.

### Arrangement of Temperature Sensor and Fan

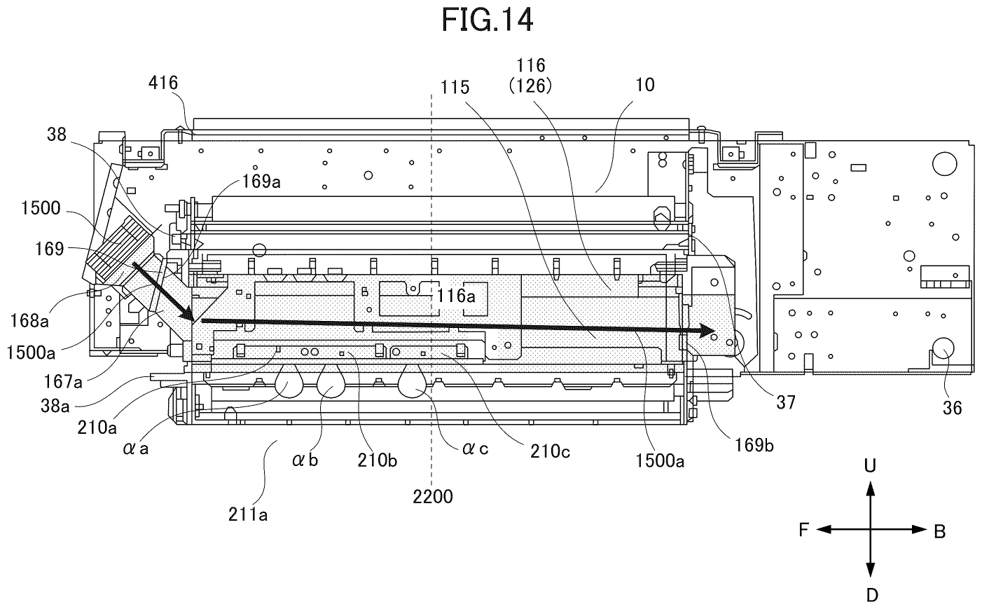

FIG. 14 is a diagram illustrating the arrangement of the temperature sensors 210a, 210b, and 210c and the arrangement of the fan 1500 according to the present embodiment. Since the same applies to the other temperature sensors 220a, 220b, and 220c, 230a, 230b, and 230c, 240a, 240b, and 240c, and 250a, 250b, and 250c, the arrangement of the temperature sensors 210a, 210b, and 210c and the arrangement of the fan 1500 will be described below as a representative.

The difference from the first embodiment is that the number of temperature sensors that detect the belt temperature immediately below each heater increases. As in the first embodiment, the temperature sensors 210a, 210b, and 210c are disposed close to the fan 1500 in the front-rear direction (width direction) to suppress a temperature rise of the temperature sensors 210a, 210b, and 210c. That is, in the present embodiment, all the temperature sensors 210a, 210b, and 210c are disposed closer to the fan 1500 than to the center 2200 of the upper belt 30 in the width direction.

However, in consideration of the length of the substrate where the temperature sensors 210a, 210b, and 210c are configured, when the plurality of the temperature sensors 210a, 210b, and 210c are arranged side by side in the width direction, it may be difficult to arrange all the temperature sensors 210a, 210b, and 210c closer to the fan 1500 than to the center 2200 of the upper belt 30 in the width direction. In this case, the plurality of the temperature sensors 210a, 210b, and 210c may be disposed more upstream of the center in the width direction of the upper belt 30 than downstream of the center in the width direction of the upper belt 30 with respect to the direction of the airflow flowing through the flow path 160a.

When the respective regions of the upper belt 30 that can be detected by the temperature sensors 210a, 210b, and 210c are detection regions aa, ab, and ac, the plurality of the temperature sensors 210a, 210b, and 210c may be disposed in the direction of the airflow flowing through the flow path 160a such that an area upstream of the center in the width direction of the upper belt 30 of a total area of the detection regions aa, ab, and ac of the plurality of the temperature sensors 210a, 210b, and 210c is larger than an area downstream of the center in the width direction of the upper belt 30 of the total area. The detection region is a region of the upper belt 30 within the range of the viewing angle 3804 described with reference to FIGS. 9A to 9C.

In addition, in a case where there is a temperature distribution in the width direction of the upper belt 30, if a temperature at the hottest point in the temperature distribution is detected, it is possible to directly set a threshold that does not exceed the limit temperature of the upper belt 30. In a case where it is difficult to detect the hottest point in the temperature distribution, it is possible to stop the heater before reaching the limit temperature of the belt by setting the detection threshold to a different value from the temperature at the temperature sensor position not to exceed the limit temperature of the belt. The case where it is difficult to detect the hottest point in the temperature distribution is, for example, a case where a plurality of the temperature sensors are disposed in the width direction as in the present embodiment, in which it is physically difficult to detect the hottest point in the temperature distribution because the interval at which the temperature sensors are disposed is narrow.

In the present embodiment, by arranging a plurality of the temperature sensors, the heater can be safely stopped even if a defect such as a failure occurs in one temperature sensor. In such a configuration according to the present embodiment, the fan 1500 is a fan disposed upstream of the flow path 160a in the direction indicated by the arrow 1500a to supply air into the flow path 160a. However, the fan may be a fan that exhausts air downstream in the direction indicated by the arrow 1500a, or may include both a fan for supplying air and a fan for exhausting air. In a case where the fan that exhausts air is disposed downstream in the direction indicated by the arrow 1500a, the same effect can be obtained by disposing the temperature sensor far from the fan.

### Third Embodiment

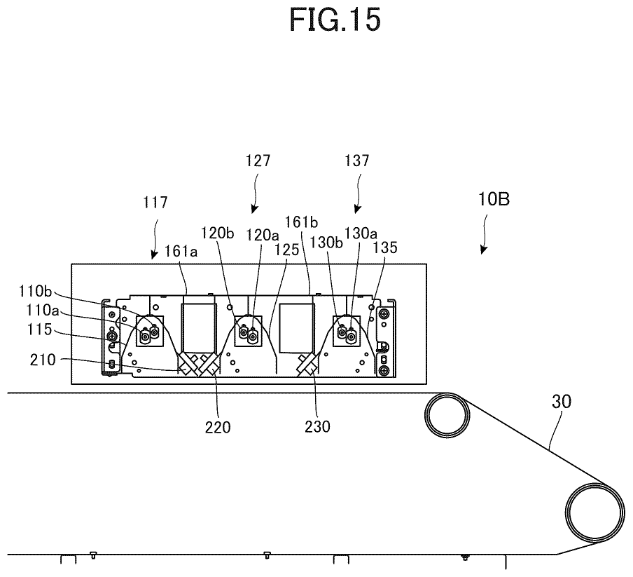

A third embodiment will be described with reference to FIG. 15. In the first embodiment described above, the configuration in which the heating unit including the heating portions 117, 127, and 137 is disposed inside the upper belt 30 has been described. On the other hand, in the present embodiment, the heating unit is disposed outside the upper belt 30. Since the other configurations and operations are similar to those in the first embodiment described above, the same configurations are denoted by the same reference signs, description and illustration thereof are omitted or simplified, and hereinafter, differences from the first embodiment will be mainly described.

FIG. 15 is an enlarged cross-sectional view illustrating a part of an upper belt unit 10B according to the present embodiment. Since the configuration and action according to the present embodiment in the lower belt unit is similar to those in the upper belt unit 10B, the description of the lower belt unit is omitted.

In the present embodiment, the heating unit including the heating portions 117, 127, and 137 is disposed outside the upper belt 30. By arranging the heating unit including the heating portions 117, 127, and 137 outside the upper belt 30, a space inside the upper belt unit 10 can be secured, and the degree of freedom in arranging various members can be increased. On the other hand, there are disadvantages in that the size of the apparatus is increased and the nip portion N cannot be disposed to be directly heated.

The members (the heaters, the reflectors, the flow paths, and the temperature sensors) constituting the heating portions 117, 127, and 137 are the same as those in the first embodiment. Even when the heating portions 117, 127, and 137 are disposed outside the upper belt 30, it is possible to obtain the same effect as that of the first embodiment against the temperature rise of the temperature sensors 210, 220, and 230. In the configuration according to the present embodiment, a plurality of the temperature sensors may be disposed in the width direction as in the second embodiment.

### Fourth Embodiment

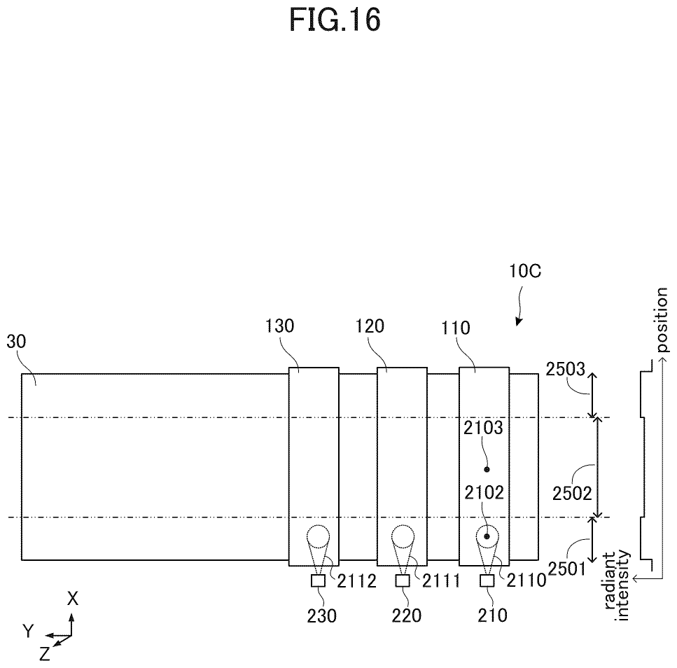

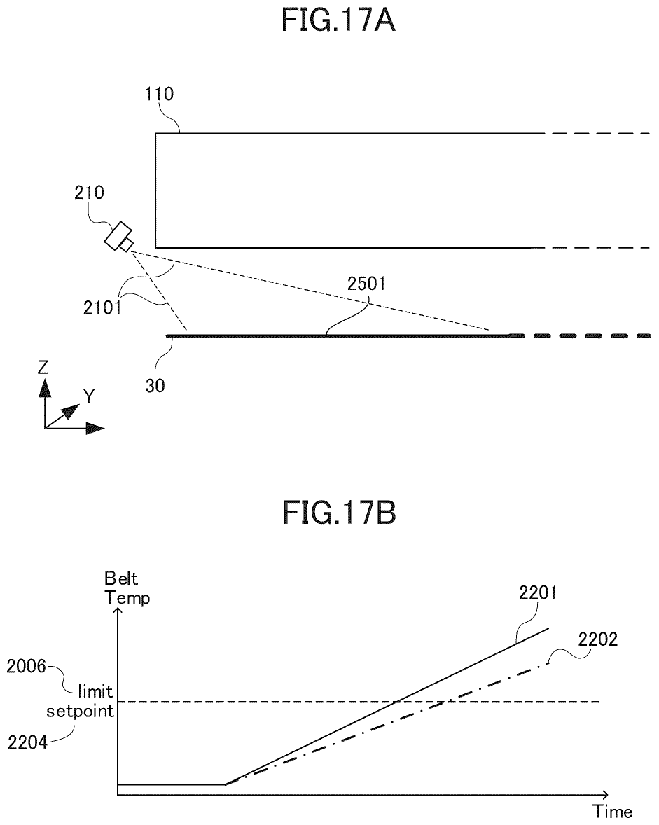

A fourth embodiment will be described with reference to FIGS. 16 to 17B. In the first embodiment described above, the configuration in which the temperature sensors 210, 220, and 230 are disposed in the flow paths 160a and 160b through which the airflow flows has been described. On the other hand, in the present embodiment, the temperature sensors 210, 220, and 230 are disposed outside the ends of the heaters in the width direction. Since the other configurations and operations are similar to those in the first embodiment described above, the same configurations are denoted by the same reference signs, description and illustration thereof are omitted or simplified, and hereinafter, differences from the first embodiment will be mainly described. In the following description, a case where the present embodiment is applied to the upper belt unit 10 will be described, but the present embodiment is similarly applicable to the lower belt unit 20.

In the first embodiment described above, an air flow is created using the fans 1500 and 1501 between the reflector 115 and the reflector 125 and between the reflector 125 and the reflector 135, where the temperature sensors 210, 220, and 230 are arranged, and the temperature sensors 210, 220, and 230 are arranged at positions close to the fans 1500 and 1501, so that the temperature sensors can stably detect the temperature of the upper belt 30. In the present embodiment, the temperature sensors can stably detect the temperature of the upper belt 30 without forming such an air flow. In the present embodiment, since no air flow is formed, the flow path forming portions 161a and 161b as described in the first embodiment are not provided.

FIG. 16 illustrates the arrangement of the upper belt 30, heaters 110, 120, and 130, and the temperature sensors 210, 220, and 230 when an upper belt unit 10C according to the present embodiment is viewed from above. The heaters 110, 120, and 130 correspond to the heaters 110a and 110b, 120a and 120b, and 130a and 130b in the first embodiment, but the plurality of heaters are illustrated as one heater for convenience of explanation. In the present embodiment, since the temperature sensors 210, 220, and 230 are not disposed between the reflector 115 and the reflector 125 and between the reflector 125 and the reflector 135, the arrangement relationship between the heaters 110a and 110b, 120a and 120b, and 130a and 130b may be different from that in the first embodiment, and for example, a heater having a large power and a heater having a small power can be freely disposed as compared with the first embodiment. In the present embodiment, one heater may be provided in each heating portion.

The temperature sensors 210, 220, and 230 are disposed to detect temperatures immediately below the heaters 110, 120, and 130, respectively. That is, the temperature sensors 210, 220, and 230 are disposed outside the ends of the heaters 110, 120, and 130 in the width direction at positions where the temperature of the upper belt 30 in certain regions can be detected from the outside of the reflectors (not illustrated) to detect the temperature of the upper belt 30.

FIG. 17A is a diagram illustrating a positional relationship between the upper belt 30 and the temperature sensor 210 when viewed from the upstream side to the downstream side in the sheet conveyance direction. The temperature sensor 210 disposed outside the end of the upper belt 30 is disposed to obliquely detect an end region 2501 of the upper belt 30. The temperature sensor 210 is disposed such that the heater 110 does not enter a detection region 2101 in order to directly look into a heated region immediately below the heater 110. The detection region 2101 is a region of the upper belt 30 within the range of the viewing angle 3804 described with reference to FIGS. 9A to 9C.

When the temperature sensor 210 is disposed in this manner, the depression angle of the temperature sensor 210 with respect to the upper belt 30 becomes larger. As the depression angle of the temperature sensor 210 increases, the detection region 2101 includes a wider belt region. Therefore, it is necessary to use a sensor of which the detection region 2101 is in a narrow range as the temperature sensor 210, or to provide a margin for detecting an excessive temperature rise by taking into consideration that a wide range of belt temperature is detected.

FIG. 17B is a diagram illustrating a relationship between a heating time and a belt temperature at each position in the width direction of the upper belt 30 when the upper belt 30 is continuously heated by the heater 110. The horizontal axis represents a time, and the vertical axis represents a belt temperature. A graph 2201 indicates a temperature rise at an end position 2102 (FIG. 16) immediately below the heater 110. A graph 2202 indicates a temperature rise at a central position 2103 (FIG. 16) immediately below the heater 110. The difference in slope of temperature rise between the graph 2201 and the graph 2202 is a difference in heater light distribution (the right end diagram of FIG. 16).

In the present embodiment, the temperature sensor 210 detects a temperature at the end position 2102, which is a region with the highest temperature rise rate. Therefore, a limit temperature 2006 of the upper belt 30 and an excessive temperature rise detection threshold temperature 2204 are the same temperature. Note that the relationship between the limit temperature and the excessive temperature rise detection threshold temperature in the present embodiment is merely an example, and is not limited thereto. For example, the excessive temperature rise detection threshold temperature 2204 may have a safety margin, and may be set to a value lower than the limit temperature 2206. The above-described configuration of the temperature sensor 210 is similarly applicable to the other temperature sensors 220 and 230.

### Fifth Embodiment

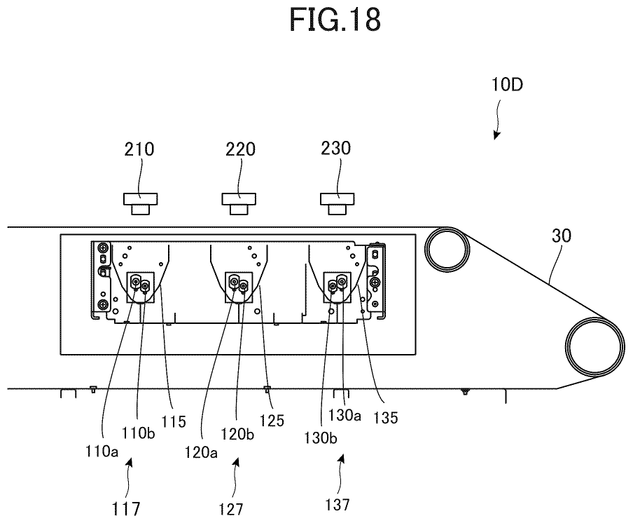

A fifth embodiment will be described with reference to FIG. 18. In the first embodiment described above, the configuration in which the temperature sensors 210, 220, and 230 are disposed in the flow paths 160a and 160b through which the airflow flows inside the upper belt 30 has been described. On the other hand, in the present embodiment, the temperature sensors 210, 220, and 230 are disposed on the side opposite to the side on which the heaters and the reflectors are disposed of the upper belt 30. Since the other configurations and operations are similar to those in the first embodiment described above, the same configurations are denoted by the same reference signs, description and illustration thereof are omitted or simplified, and hereinafter, differences from the first embodiment will be mainly described. In the following description, a case where the present embodiment is applied to the upper belt unit 10 will be described, but the present embodiment is similarly applicable to the lower belt unit 20.

In the present embodiment, similarly to the above-described fourth embodiment, the temperature sensors can stably detect the temperature of the upper belt 30 without forming an air flow. In the present embodiment, since no air flow is formed, the flow path forming portions 161a and 161b as described in the first embodiment are not provided.

FIG. 18 is an enlarged cross-sectional view illustrating a part of an upper belt unit 10D according to the present embodiment. Since the configuration and action according to the present embodiment in the lower belt unit is similar to those in the upper belt unit 10D, the description of the lower belt unit is omitted. In the present embodiment, similarly to the fourth embodiment, since the temperature sensors 210, 220, and 230 are not disposed between the reflector 115 and the reflector 125 and between the reflector 125 and the reflector 135, the arrangement relationship between the heaters 110a and 110b, 120a and 120b, and 130a and 130b may be different from that in the first embodiment, and for example, a heater having a large power and a heater having a small power can be freely disposed as compared with the first embodiment. For example, the heaters may be arranged as illustrated in FIG. 18.

In the present embodiment, the heating unit including the heating portions 117, 127, and 137 heats the inner surface on the side (upper side) opposite to the nip portion N inside the upper belt 30. The temperature sensors 210, 220, and 230 are disposed at positions facing the heaters 110a and 110b, 120a and 120b, and 130a and 130b of the heating portions 117, 127, and 137, respectively, on the outer surface of the upper belt 130 via the upper belt 30. That is, the temperature sensors 210, 220, and 230 are disposed on the side opposite to the side where the heaters 110a, 110b, 120a, 120b, 130a, and 130b and the reflectors 115, 125, and 135 are disposed of the upper belt 30, and detects the temperatures in certain regions of the back surface of the upper belt 30.

In the present embodiment, the heating unit including the heating portions 117, 127, and 137 is disposed to heat the inner surface of the upper belt 30 other than the nip portion N, and the temperature sensors 210, 220, and 230 are disposed to detect the temperature of the outer surface of the upper belt 30. As a result, since the temperature sensors 210, 220, and 230 are not disposed near the reflectors 115, 125, and 135, it is possible to suppress a rise in temperature of the temperature sensors 210, 220, and 230. On the other hand, there are disadvantages in that the size of the apparatus is increased and the nip portion N cannot be disposed to be directly heated. In the configuration according to the present embodiment, a plurality of the temperature sensors may be disposed in the width direction as in the second embodiment.

### Other Embodiments

In each of the embodiments described above, the case where the present invention is applied to the fixing unit (fixing belt unit) of the inkjet recording apparatus has been described, but the application of the present invention is not limited thereto. For example, the present invention can also be applied to a fixing unit of an electrophotographic image forming apparatus using a toner or the like, and the same effects as those of each of the embodiments can be obtained.

In each of the embodiments described above, the temperature sensors 210, 220, 230, 240, and 250 are used as sensors that detect an excessive temperature rise of the belt and stop supplying power to the heaters. These temperature sensors 210, 220, 230, 240, and 250 may be used to control the temperatures of the heaters.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-051922, filed Mar. 27, 2024, which is hereby incorporated by reference herein in its entirety.

What is claimed is:

1. A fixing unit comprising:
an endless belt configured to heat a sheet on which an ink image is formed to fix the image onto the sheet;
a heater disposed inside the belt in such a manner as not to be in contact with the belt and configured to heat the belt by emitting an electromagnetic wave;
a reflecting member configured to reflect the electromagnetic wave emitted by the heater toward a region of the belt, with the heater being disposed inside the reflecting member,
a temperature detection unit disposed outside the reflecting member and configured to detect a temperature of the region;
a fan configured to generate an airflow, and
a flow path forming portion provided inside the belt and forming a flow path through which the airflow generated from the fan flows,
wherein the temperature detection unit is disposed inside the flow path forming portion.

2. The fixing unit according to claim 1, wherein
the temperature detection unit is disposed adjacent to the reflecting member in a rotation direction of the belt.

3. The fixing unit according to claim 1, wherein
the heater is a first heater,
the fixing unit further comprises a second heater disposed together with the first heater inside the reflecting member in such a manner as not to be in contact with the belt, and configured to heat the belt by emitting an electromagnetic wave, the second heater having a power smaller than a power of the first heater,
the reflecting member is configured to reflect electromagnetic waves emitted from the first heater and the second heater toward the region of the belt, and
the temperature detection unit is disposed at a position closer to the second heater than to the first heater.

4. The fixing unit according to claim 3, wherein
the reflecting member is a first reflecting member configured to reflect the electromagnetic waves emitted from the first heater and the second heater toward a first region of the belt,
the temperature detection unit is disposed at a position where a temperature of the belt in the first region is detectable,
the fixing unit further comprises:
a third heater disposed in such a manner as not to be in contact with the belt, and configured to heat the belt by emitting an electromagnetic wave;
a fourth heater disposed in such a manner as not to be in contact with the belt, and configured to heat the belt by emitting an electromagnetic wave, the fourth heater having a power smaller than a power of the third heater, and
a second reflecting member configured to reflect electromagnetic waves emitted from the third heater and the fourth heater toward a second region of the belt, with the third heater and the fourth heater being disposed inside the second reflecting member, and
wherein the temperature detection unit is disposed between the first reflecting member and the second reflecting member in a rotation direction of the belt at a position closer to the second heater than to the first heater and closer to the fourth heater than to the third heater.

5. The fixing unit according to claim 4, wherein
the temperature detection unit is a first temperature detection unit,
the fixing unit further comprises a second temperature detection unit disposed at a position where a temperature of the belt in the second region is detectable from an outside of the second reflecting member, and configured to detect the temperature of the second region, and
the second temperature detection unit is disposed between the first reflecting member and the second reflecting member in the rotation direction of the belt at the position closer to the second heater than to the first heater and closer to the fourth heater than to the third heater.

6. The fixing unit according to claim 1, wherein
the heater and the reflecting member are disposed along a width direction of the belt intersecting a rotation direction of the belt, and
the temperature detection unit is one of a plurality of temperature detection units disposed along the width direction.

7. The fixing unit according to claim 1, wherein
the fan is disposed outside the belt in a width direction of the belt intersecting a rotation direction of the belt.

8. The fixing unit according to claim 6, wherein
the flow path is formed along the width direction, and
in a case where regions of the belt whose temperature can be detected by the plurality of the temperature detection units are defined as detection regions, the plurality of the temperature detection units are arranged in a direction of the airflow flowing through the flow path such that in a total area of the detection regions of the plurality of the temperature detection units, an area upstream of a center in the width direction of the belt is larger than an area downstream of the center in the width direction of the belt.

9. The fixing unit according to claim 7, wherein
the fan is disposed only on one side of both sides of the belt in the width direction.

10. The fixing unit according to claim 1, wherein
in a case where a line drawn from the heater toward the reflecting member in a direction orthogonal to a perpendicular line drawn from the heater to the belt and orthogonal to a width direction of the belt intersecting a rotation direction of the belt is defined as an incident light segment, a point at which the incident light segment intersects an inner surface of the reflecting member is defined as a first intersection, a line drawn from the first intersection such that an incident angle and a reflection angle are same in relation to the incident light segment is defined as a reflected light segment, a point at which the reflected light segment intersects the belt is defined as a second intersection, and a point at which a perpendicular line drawn from the first intersection to the belt intersects the belt is defined as a third intersection,
the heater is disposed such that the second intersection is located closer to the heater than to the third intersection in the rotation direction of the belt.

11. The fixing unit according to claim 1, wherein
a part of the reflecting member constitutes the flow path forming portion.

12. The fixing unit according to claim 1, further comprising:
a power supply unit configured to supply power to the heater, and
a threshold determination unit configured to stop the power supply of the power supply unit when a temperature detected by the temperature detection unit is equal to or higher than a threshold.

13. A fixing unit comprising:
an endless belt configured to heat a sheet on which an ink image is formed to fix the image onto the sheet;
a first heater and a second heater disposed inside the belt in such a manner as not to be in contact with the belt and configured to heat the belt by emitting electromagnetic waves;
a first reflecting member configured to reflect the electromagnetic wave emitted by the first heater toward a first region of the belt, with the first heater being disposed inside the first reflecting member,
a second reflecting member configured to reflect the electromagnetic wave emitted by the second heater toward a second region of the belt, with the second heater being disposed inside the second reflecting member,
a temperature detection unit disposed outside the first reflecting member and the second reflecting member, and configured to detect a temperature one of the first region and the second region; and
a fan configured to generate an airflow,
wherein the airflow generated from the fan flows in a width direction of the belt intersecting a rotation direction of the belt along a part of the first reflecting member and a part of the second reflecting member, and
the temperature detection unit is disposed in a flow path through which the airflow generated from the fan flows.

14. The fixing unit according to claim 13, wherein
the temperature detection unit is disposed adjacent to the reflecting member in the rotation direction of the belt.

15. The fixing unit according to claim 13, wherein
the heater is a first heater,
the fixing unit further comprises a second heater disposed together with the first heater inside the reflecting member in such a manner as not to be in contact with the belt, and configured to heat the belt by emitting an electromagnetic wave, the second heater having a power smaller than a power of the first heater,
the reflecting member is configured to reflect electromagnetic waves emitted from the first heater and the second heater toward the region of the belt, and
the temperature detection unit is disposed at a position closer to the second heater than to the first heater.

16. The fixing unit according to claim 13, wherein
the fan is disposed outside the belt in the width direction of the belt.

17. The fixing unit according to claim 13, wherein
the flow path is formed along the width direction,
the temperature detection unit is one of a plurality of temperature detection units disposed along the width direction, and
in a case where regions of the belt whose temperature can be detected by the plurality of the temperature detection units are defined as detection regions, the plurality of the temperature detection units are arranged in a direction of the airflow flowing through the flow path such that in a total area of the detection regions of the plurality of the temperature detection units, an area upstream of a center in the width direction of the belt is larger than an area downstream of the center in the width direction of the belt.

18. The fixing unit according to claim 13, further comprising:
a power supply unit configured to supply power to the heater, and
a threshold determination unit configured to stop the power supply of the power supply unit when a temperature detected by the temperature detection unit is equal to or higher than a threshold.
